(19) United States
(12) Patent Application Publication
(10) Pub. No.: US 2026/0004322 A1
(43) Pub. Date: Jan. 1, 2026

(54) METHOD AND SYSTEM FOR DETECTION OF ADVERTISEMENT FRAUD

(71) Applicant: Affle (India) Limited, Mumbai City (IN)

(72) Inventors: Anuj Khanna SOHUM, Singapore (SG); Charles Yong Jien FOONG, Singapore (SG)

(73) Assignee: Affle (India) Limited, Mumbai City (IN)

(21) Appl. No.: 19/317,077

(22) Filed: Sep. 2, 2025

Related U.S. Application Data
(63) Continuation-in-part of application No. 16/653,863, filed on Oct. 15, 2019.

(30) Foreign Application Priority Data
Apr. 30, 2018 (IN) 201821016229

(51) Int. Cl. G06Q 30/0241; H04L 9/40

(52) U.S. Cl. CPC G06Q 30/0248; H04L 63/1425

(57) ABSTRACT

A computer-implemented method is disclosed for detecting advertisement fraud in real-time using a multi-modal analysis framework. The method involves receiving user data and user action data from a media device, including demographic information and sensor-based interaction metrics such as accelerometer, gyroscope, and touch sensor data. These inputs are processed by an advertisement fraud detection system equipped with a processor and hardware-run algorithms, including a multi-modal machine learning model that distinguishes human from non-human interactions. Fraudulent actions are identified by detecting deviations from predefined behavioral baselines enriched with campaign-level intelligence. The system further analyzes historical ad performance to identify downtime periods characterized by low human activity and high fraud probability. During these periods, fake advertisements are adaptively inserted based on contextual mismatches to confirm fraudulent behavior. Upon detection, notifications are dispatched to advertisers via multiple communication mediums.

### CROSS-REFERENCE TO RELATED APPLICATIONS

This application is a Continuation-in-Part of U.S. patent application Ser. No. 16/653,863, filed on Oct. 15, 2019, entitled “METHOD AND SYSTEM FOR DETECTION OF ADVERTISEMENT FRAUD,” the entire contents of which are incorporated herein by reference. This Continuation-in-Part application includes additional subject matter related to enhanced real-time fraud detection techniques, including novel sensor-based physical interaction verification and adaptive machine learning algorithms for on-device processing, which build upon and extend the concepts disclosed in the parent application.

### TECHNICAL FIELD

The present disclosure relates to the field of fraud detection systems and, in particular, relates to a method and system for detection of advertisement fraud.

### INTRODUCTION

With the advancements in technology over the last few years, users have predominantly shifted towards smartphones for accessing multimedia content. Nowadays, users access content through a number of applications available for download through various online application stores. Businesses (Advertisers) have started focusing on generating revenue by targeting consumers through these applications. In addition, businesses have started investing heavily in doing business with these applications. Moreover, businesses (publishers and/or advertising networks) have started developing capable advertisement applications for serving advertisements through these applications. These advertisements are published in real time or fixed placements through these applications and watched by the users. The advertisers are benefited in terms of internet traffic generated by clicking, taking action like installing or on watching these advertisements. However, certain online publishers and advertising networks working with these publishers take undue advantage of this in order to generate high revenues. These online publishers and advertising networks employ fraudulent techniques in order to generate clicks or to increase actions like increasing number of application install for the advertisers through fraudulent means. In addition, these online publishers incentivize the users for clicking on links, downloading applications and the like. This results in a loss of advertisers marketing budget spent as many times these publishers claim a normal user-initiated action (Organic action, e.g. Organic Install) as one initiated by them or at times the clicks or application installs are not driven by humans at all and instead by bots. There is a consistent need to stop publishers from performing such types of click fraud and transaction fraud.

### SUMMARY

In a first example, a computer-implemented method for detecting advertisement fraud occurring using one or more sources in real-time is implemented. The method comprises a step of receiving, at an advertisement fraud detection system with a processor, a user data and a user action data in real-time. The user data and the user action data is received from a media device associated with a user. The user data comprises data associated with demographic information of the user. The user action data comprises data associated with actions performed by the user using the media device and interaction of the user with one or more advertisements. The user action data further comprises real-time sensor data from the media device including at least one of accelerometer data, gyroscope data, and touch sensor data. The method comprises a step of analyzing, at the advertisement fraud detection system with the processor, the user data and the user action data in real-time. The user data and the user action data is analyzed with facilitation of one or more hardware-run algorithms comprising a multi-modal machine learning model that processes the real-time sensor data to distinguish human interactions from non-human interactions. The method comprises a step of detecting, at the advertisement fraud detection system with the processor, one or more fraudulent actions in real-time. The one or more fraudulent actions are detected based on deviation in the user data and the user action data from a predefined user data and a predefined user action data respectively. The deviation is detected by mapping the user data and the user action data against a baseline human behavior profile enriched with campaign-level intelligence including at least one of time-based offers, context-based promotions, and co-branding initiatives. The method comprises a step of identifying, at the advertisement fraud detection system with the processor, a downtime period based on historical ad performance data and statistical analysis of low human activity periods relative to high fraudulent activity. The method comprises a step of inserting, at the advertisement fraud detection system with the processor, a set of advertisements along with the one or more advertisements in real-time during the downtime period. The set of advertisements are fake advertisements inserted to attract the one or more sources performing the advertisement fraud. The set of advertisements are adaptively selected based on real-time contextual data including at least one of user location, user language, and application context to create a contextual mismatch, wherein the set of advertisements are inserted in one or more formats. The set of advertisements are inserted for confirming the one or more fraudulent actions performed by the one or more sources for determining the advertisement fraud. The method comprises a step of sending, at the advertisement fraud detection system with the processor, one or more notifications for alerting an advertiser. The one or more notifications are sent to the advertiser with facilitation of one or more mediums, wherein the one or more notifications are sent based on the one or more fraudulent actions performed using the one or more sources.

In an embodiment of the present disclosure, the user data comprising name, location, IP address, age, gender, culture, religion, marital status, nationality, education level and demographic information of the user, wherein the user action data comprising number of clicks, number of impressions, one or more transactions, one or more purchases, number of advertisements, user behavior, and the real-time sensor data including touch position, touch pressure, touch footprint, accelerometer readings, and gyroscope readings.

In an embodiment of the present disclosure, the one or more sources comprising at least one of malicious websites, an internet bot, web bot program, viruses, robots, and web crawlers.

In an embodiment of the present disclosure, the set of advertisements comprising honeypot based advertisement campaign, zero pixel advertisements, blurred advertisements, content based advertisements, and non-human clickable advertisements. The set of advertisements further comprise dynamic signatures embedded via steganographic techniques including encoding expected click coordinates and one-time tokens in pixel color values.

In an embodiment of the present disclosure, the one or more formats comprising at least one of display ads, social media ads, video ads, e-mail ads, text advertisement, audio advertisements, and graphical advertisements.

In an embodiment of the present disclosure, the one or more hardware-run algorithms comprising at least one of machine learning algorithms, artificial intelligence algorithms, neural network algorithms, and deep learning algorithms. The multi-modal machine learning model comprises a hybrid approach including an isolation forest for initial anomaly detection, a gradient boosting machine for classification, and a long short-term memory network for sequential analysis.

In an embodiment of the present disclosure, the one or more fraudulent actions comprising number of fraud clicks, fraudulent location, number of fake conversation, fraudulent behavior, fraudulent device, and fraudulent IP address. The fraudulent actions further comprise impossible travel patterns detected across sequential locations and lack of correlation with connected TV impressions in a household.

In an embodiment of the present disclosure, the one or more mediums comprising text message, email, voice notification, voice call, flash message, notification, mms and OTA messages.

In an embodiment of the present disclosure, the method further comprises mapping, at the advertisement fraud detection system with the processor, the user data with the predefined user data and the user action data with the predefined user action data. The mapping is performed for detecting deviation in the user data from the predefined user data and deviation in the user action data from the predefined user action data, wherein the mapping is performed for detecting the advertisement fraud performed by a fraudulent publisher. The mapping calculates a Mahalanobis distance between feature vectors and a dynamic threshold based on historical data.

In an embodiment of the present disclosure, the method further comprises blocking, at the advertisement fraud detection system with the processor, the one or more fraudsters. The one or more fraudsters are blocked in real time. The blocking of the one or more fraudsters is performed based on the one or more fraudulent actions.

In an embodiment of the present disclosure, the method further comprises performing a behavioral captcha analysis, wherein the behavioral captcha comprises analyzing interaction trajectory, micro-movement feedback from accelerometer data, and rotational feedback from gyroscope data during user interaction with an ad element to confirm human presence without explicit user challenges.

In an embodiment of the present disclosure, the method further comprises applying a biometric interaction fingerprinting algorithm, the algorithm comprising capturing high-frequency sensor data from gyroscope and accelerometer during a touch event, applying a Fourier transform to generate a frequency-based signature, and classifying the signature using a neural network to distinguish human tremor patterns from flat-line bot patterns.

In an embodiment of the present disclosure, the method further comprises constructing a contextual fraud graph, wherein nodes represent entities including device IDs and IP addresses, edges represent interactions, and a graph neural network detects anomalous subgraphs indicative of coordinated fraud.

In an embodiment of the present disclosure, the multi-modal machine learning model is trained using supervised learning on labeled historical datasets comprising past interactions, with periodic retraining to adapt to evolving fraud tactics, and wherein resource consumption is tiered based on user trust levels with client-side processing for initial analysis to reduce server load.

In a second example, a computer system is disclosed. The computer system comprises one or more processors and a memory coupled to the one or more processors, the memory for storing instructions which, when executed by the one or more processors, cause the one or more processors to perform a method for detecting advertisement fraud occurring using one or more sources in real-time. The method comprises a step of receiving, at an advertisement fraud detection system with a processor, a user data and a user action data in real-time. The user data and the user action data is received from a media device associated with a user. The user data comprises data associated with demographic information of the user. The user action data comprises data associated with actions performed by the user using the media device and interaction of the user with one or more advertisements. The user action data further comprises real-time sensor data from the media device including at least one of accelerometer data, gyroscope data, and touch sensor data. The method comprises a step of analyzing, at the advertisement fraud detection system with the processor, the user data and the user action data in real-time. The user data and the user action data is analyzed with facilitation of one or more hardware-run algorithms comprising a multi-modal machine learning model that processes the real-time sensor data to distinguish human interactions from non-human interactions. The method comprises a step of detecting, at the advertisement fraud detection system with the processor, one or more fraudulent actions in real-time. The one or more fraudulent actions are detected based on deviation in the user data and the user action data from a predefined user data and a predefined user action data respectively. The deviation is detected by mapping the user data and the user action data against a baseline human behavior profile enriched with campaign-level intelligence including at least one of time-based offers, context-based promotions, and co-branding initiatives. The method comprises a step of identifying, at the advertisement fraud detection system with the processor, a downtime period based on historical ad performance data and statistical analysis of low human activity periods relative to high fraudulent activity. The method comprises a step of inserting, at the advertisement fraud detection system with the processor, a set of advertisements along with the one or more advertisements in real-time during the downtime period. The set of advertisements are fake advertisements inserted to attract the one or more sources performing the advertisement fraud. The set of advertisements are adaptively selected based on real-time contextual data including at least one of user location, user language, and application context to create a contextual mismatch, wherein the set of advertisements are inserted in one or more formats. The set of advertisements are inserted for confirming the one or more fraudulent actions performed by the one or more sources for determining the advertisement fraud. The method comprises a step of sending, at the advertisement fraud detection system with the processor, one or more notifications for alerting an advertiser. The one or more notifications are sent to the advertiser with facilitation of one or more mediums, wherein the one or more notifications are sent based on the one or more fraudulent actions performed using the one or more sources.

In a third example, a non-transitory computer-readable storage medium encoding computer executable instructions that, when executed by at least one processor, performs a method for detecting advertisement fraud occurring using one or more sources in real-time is disclosed. The method comprises a step of receiving, at an advertisement fraud detection system with a processor, a user data and a user action data in real-time. The user data and the user action data is received from a media device associated with a user. The user data comprises data associated with demographic information of the user. The user action data comprises data associated with actions performed by the user using the media device and interaction of the user with one or more advertisements. The user action data further comprises real-time sensor data from the media device including at least one of accelerometer data, gyroscope data, and touch sensor data. The method comprises a step of analyzing, at the advertisement fraud detection system with the processor, the user data and the user action data in real-time. The user data and the user action data is analyzed with facilitation of one or more hardware-run algorithms comprising a multi-modal machine learning model that processes the real-time sensor data to distinguish human interactions from non-human interactions. The method comprises a step of detecting, at the advertisement fraud detection system with the processor, one or more fraudulent actions in real-time. The one or more fraudulent actions are detected based on deviation in the user data and the user action data from a predefined user data and a predefined user action data respectively. The deviation is detected by mapping the user data and the user action data against a baseline human behavior profile enriched with campaign-level intelligence including at least one of time-based offers, context-based promotions, and co-branding initiatives. The method comprises a step of identifying, at the advertisement fraud detection system with the processor, a downtime period based on historical ad performance data and statistical analysis of low human activity periods relative to high fraudulent activity. The method comprises a step of inserting, at the advertisement fraud detection system with the processor, a set of advertisements along with the one or more advertisements in real-time during the downtime period. The set of advertisements are fake advertisements inserted to attract the one or more sources performing the advertisement fraud. The set of advertisements are adaptively selected based on real-time contextual data including at least one of user location, user language, and application context to create a contextual mismatch, wherein the set of advertisements are inserted in one or more formats. The set of advertisements are inserted for confirming the one or more fraudulent actions performed by the one or more sources for determining the advertisement fraud. The method comprises a step of sending, at the advertisement fraud detection system with the processor, one or more notifications for alerting an advertiser. The one or more notifications are sent to the advertiser with facilitation of one or more mediums, wherein the one or more notifications are sent based on the one or more fraudulent actions performed using the one or more sources.

### BRIEF DESCRIPTION OF DRAWINGS

Having thus described the invention in general terms, references will now be made to the accompanying figures, wherein:

FIG. 1A illustrates an interactive computing environment for detection of advertisement fraud occurring from one or more sources in real-time, in accordance with various embodiments of the present disclosure;

FIG. 1B illustrates a block diagram of an advertisement fraud detection system, in accordance with various embodiments of the present disclosure;

FIG. 2 illustrates a flowchart of a method for the detection of the advertisement fraud occurring from the one or more sources in real-time, in accordance with various embodiments of the present disclosure; and

FIG. 3 illustrates a block diagram of a computing device, in accordance with various embodiments of the present disclosure.

It should be noted that the accompanying figures are intended to present illustrations of exemplary embodiments of the present disclosure. These figures are not intended to limit the scope of the present disclosure. It should also be noted that accompanying figures are not necessarily drawn to scale.

### DETAILED DESCRIPTION

In the following description, for purposes of explanation, numerous specific details are set forth in order to provide a thorough understanding of the present technology. It will be apparent, however, to one skilled in the art that the present technology can be practiced without these specific details. In other instances, structures and devices are shown in block diagram form only in order to avoid obscuring the present technology.

Reference in this specification to “one embodiment” or “an embodiment” means that a particular feature, structure, or characteristic described in connection with the embodiment is included in at least one embodiment of the present technology. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Moreover, although the following description contains many specifics for the purposes of illustration, anyone skilled in the art will appreciate that many variations and/or alterations to said details are within the scope of the present technology. Similarly, although many of the features of the present technology are described in terms of each other, or in conjunction with each other, one skilled in the art will appreciate that many of these features can be provided independently of other features. Accordingly, this description of the present technology is set forth without any loss of generality to, and without imposing limitations upon, the present technology.

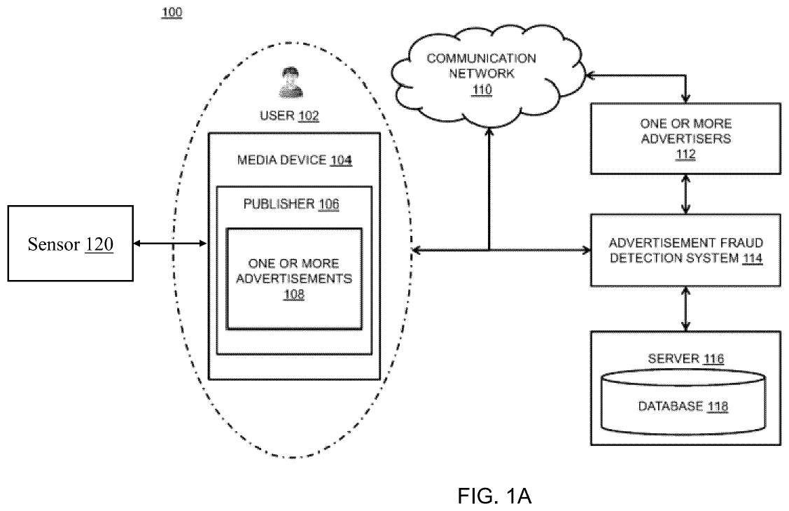

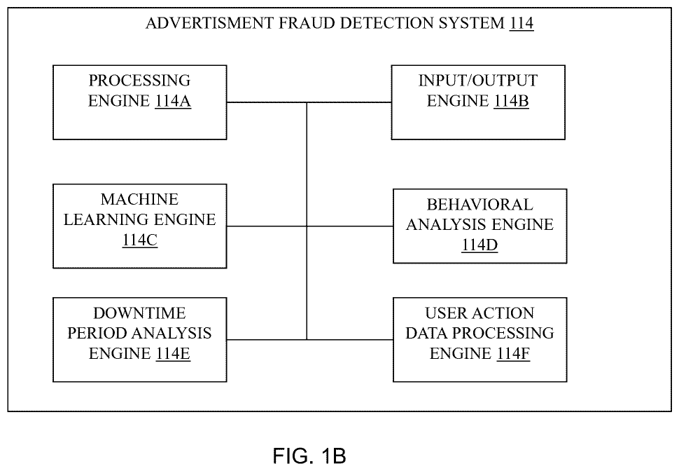

FIG. 1 illustrates an interactive computing environment 100 for detection of advertisement fraud occurring from one or more sources in real-time, in accordance with various embodiments of the present disclosure. In general, advertisement fraud is concerned with theory and practice of fraudulently representing online advertisement impressions, clicks, conversion or data events in order to generate revenue. The interactive computing environment 100 includes a user 102, a media device 104, a publisher 106 and one or more advertisements 108. In addition, the interactive computing environment 100 includes a communication network 110, one or more advertisers 112, an advertisement fraud detection system 114, a server 116 and a database 118.

The interactive computing environment 100 includes the user 102. The user 102 is a person who accesses online multimedia content. The user 102 is an individual that requires an IP based network for accessing the online multimedia content. In an embodiment of the present disclosure, the user 102 is a computer or bot. In another embodiment of the present disclosure, the user 102 includes but may not be limited to a natural person, legal entity, individual, automated machine and robot. In general, automated machine or robot is programmed to perform a task on its own. The user 102 utilizes the media device 104 to access the online multimedia content. The user 102 is a person that accesses the media device 104 to view the one or more advertisements 108. The user 102 is a person that clicks on the one or more advertisements 108 in order to know more about product, business, or service offered by the one or more advertisements 108. The user 102 is a person that accesses the one or more advertisements 108 through the media device 104.

The interactive computing environment 100 includes the media device 104. The media device 104 is associated with the user 102. In an embodiment of the present disclosure, the media device 104 is used to display the online multimedia content to the user 102. In an embodiment of the present disclosure, the on line multimedia content includes the one or more advertisements 108. In addition, the media device 104 is used to view an application installed on the media device 104. In general, media device is an equipment or device capable of transmitting analog or digital signals through communication wire or remote way. The media device 104 includes but may not be limited to smartphone, laptop, personal computer, tablet, smart watch, gesture-controlled devices and personal digital assistant. In an embodiment of the present disclosure, the media device 104 includes smart television, workstation, an electronic wearable device and the like. In addition, the media device 104 is connected to an active internet connection. In an embodiment of the present disclosure, the media device 104 is used to view multimedia content on the publisher 106. In an embodiment of the present disclosure, the user 102 access the media device 104 while moving from one place to another. In an example, place includes home, park, restaurant, any facility, college, university, office and the like.

The interactive computing environment 100 includes the publisher 106. The publisher 106 is an application which is used to view the online multimedia content on the media device 104 to the user 102. The online multimedia content includes at least one of text content, video content, audio content, graphical content and the like. In an embodiment of the present disclosure, the publisher 106 is installed on each of the media device 104. The publisher 106 includes but may not be limited to mobile application, web application, web browser and website. In an embodiment of the present disclosure, the publisher 106 displays the online multimedia content related to interest of the user 102. In an example, the user 102 may be interested in watching online videos, reading biogs, playing online games, accessing shopping websites, accessing social networking sites and the like.

In yet another embodiment of the present disclosure, the publisher 106 may be advertisement supporting applications which are installed on the media device 104. The publisher 106 includes but may not be limited to the advertisement supporting applications such as gaming applications, utility applications and service based applications. The publisher 106 provides space, frame, area or a part of application pages for advertising purposes. The space, frame, area or a part of application pages are referred to as advertisement slots. The publisher 106 has various advertisement slots. The publisher 106 advertises products, services or businesses to the user 102 for generating revenue. The publisher 106 displays the one or more advertisements 108 on the media device 104 when the user 102 accesses the publisher 106.

The interactive computing environment 100 includes the one or more advertisements 108. The one or more advertisements 108 are an audio or visual form of marketing communication to promote or sell any product, service or business. In an embodiment of the present disclosure, the one or more advertisements 108 are a graphical or pictorial representation of information in order to promote any product, an event, service and the like. The one or more advertisements 108 include at least one of display ads, social media ads, video ads, email ads, text advertisement, audio advertisements, graphical advertisements and the like. In an embodiment of the present disclosure, the one or more advertisements 108 are displayed in third party applications developed by the publisher 106. The one or more advertisements 108 are displayed on the media device 104 to attract the user 102 in order to generate revenue. The one or more advertisements 108 are genuine advertisements that are clicked by the user 102 on the media device 104 to generate revenue for the advertiser. In an example, the one or more advertisements 108 include advertisement of a biscuit company coming on Youtube before start of the intended video the user 102 clicked on.

In yet another example, the one or more advertisements 108 include advertisement of shampoo brand coming up in between a Facebook video being viewed by the user 102. In an embodiment of the present disclosure, the one or more advertisements 108 are advertisement campaigns which are executed by the publisher 106. The one or more advertisements 108 are provided to the publisher 106 by the one or more advertisers 112. In general, a campaign is a planned set of activities that is carried out over a period of time in order to achieve a certain goal. In addition, advertisement campaigns are campaigns that are targeted to certain number of users in order to achieve a set of goals.

In an embodiment of the present disclosure, the one or more advertisements 108 are displayed to the user 102 based on interest of the user 102. The user 102 may or may not click on the one or more advertisements 108. The user 102 is redirected to website or application upon clicking on the one or more advertisements 108. In an embodiment of the present disclosure, the user 102 is redirected to a store for installing application upon clicking on the one or more advertisements 108. In an example, the store includes but may not be limited to online stores, application store, third party store, web store, apple store and playstore. The one or more advertisements 108 are provided to the publisher 106 by the one or more advertisers 112 who want to advertise their product through the publisher 106. In addition, the publisher 106 gets paid or rewarded if the user 102 visits the website or the application through the one or more advertisements 108.

The interactive computing environment 100 includes the communication network 110. The communication network 110 denotes channels of communication (networks by which information flows). In an embodiment of the present disclosure, the communication network 110 includes LAN, MAN, WAN, and the like. In general, local area network, or LAN, cable or fiber, is used to connect computer equipment and other terminals distributed in the local area, such as in the university campus. In addition, Metropolitan Area Network or MAN is a high-speed network that is used to connect a small geographical area such as a LAN across the city. Further, Wide area networks, or any communication connections, including WAN, microwave radio link and satellite, are used to connect computers and other terminals to a larger geographic distance.

In an embodiment of the present disclosure, the communication network 110 may be any type of network that provides internet connectivity to the advertisement fraud detection system 114. In another embodiment of the present disclosure, the communication network 110 may be any type of network that provides internet connectivity to the media device 104. In an embodiment of the present disclosure, the communication network 110 is a wireless mobile network. In another embodiment of the present disclosure, the communication network 110 is a wired network with finite bandwidth. In yet another embodiment of the present disclosure, the communication network 110 is a combination of the wireless and the wired network for optimum throughput of data transmission. In yet another embodiment of the present disclosure, the communication network 110 is an optical fibre high bandwidth network that enables high data rate with negligible connection drops. In yet another embodiment of the present disclosure, the communication network 110 provides medium to the media device 104 to connect to the advertisement fraud detection system 114. In this scenario, the communication network 110 may be a global network of computing devices such as the Internet. The communication network 110 provides network connectivity to elements of the interactive computing environment 100.

The interactive computing environment 100 includes the one or more advertisers 112. The one or more advertisers 112 may be a person, an organization, a group of persons or a company who wants to advertise their product, service, business and the like. The one or more advertisers 112 approach the publisher 106 and provide the one or more advertisements 108 to be displayed on the publisher 106. The one or more advertisers 112 pay or rewards the publisher 106 based on number of clicks of number of users redirected to the product, the service or the business of the one or more advertisers 112. In an embodiment of the present disclosure, the one or more advertisers 112 pay or rewards the publisher 106 based on number of users who download the application. Moreover, the application is downloaded from the store after clicking on the one or more advertisements 108. The publisher 106 wants more and more number of users to click on the one or more advertisements 108 in order to generate a high amount of revenue.

The one or more advertisements 108 are placed in advertisement slots of the publisher 106 on the media device 104. The one or more advertisers 112 purchase the advertisement slots from the publisher 106. The one or more advertisements 108 are served based on a real-time bidding technique or a direct contract between the one or more advertisers 112 and the publisher 106. The one or more advertisers 112 provide the one or more advertisements 108 to advertising networks and information associated with the advertisement campaigns. The advertisement networks enable display of the one or more advertisements 108 on the publisher 106 on behalf of one or more advertisers 112 in real-time. The advertising networks are entities that connect the one or more advertisers 112 to the publisher 106 or the applications that are willing to serve the one or more advertisements 108.

The interactive computing environment 100 includes the advertisement fraud detection system 114. The advertisement fraud detection system 114 is associated with the publisher 106 and the one or more advertisers 112. The advertisement fraud detection system 114 detects advertisement fraud in the one or more advertisements 108 in the online multimedia content and may block fraudulent advertising traffic. The advertisement fraud detection system 114 detects the advertisement fraud occurring through one or more sources in real-time. The one or more sources include but may not be limited to malicious websites, an internet bot, web bot program, viruses, robots, and web crawlers. In an embodiment of the present disclosure, the one or more sources are implemented by the publisher 106 in order to generate more revenue based on more number of clicks on the one or more advertisements 108. In addition, the advertisement fraud detection system 114 blocks the one or more sources that perform activities such as click spamming to simulate fake traffic. In an embodiment of the present disclosure, the advertisement fraud detection system 114 blocks the publisher 106 that implements fraudulent methods such as the one or more sources to simulate fake traffic. Further, the advertisement fraud detection system 114 alerts the one or more advertisers 112 about the publisher 106 or the one or more sources that simulate fake traffic in real time.

The advertisement fraud detection system 114 receives a user data and a user action data in real-time. The advertisement fraud detection system 114 receives the user data and the user action data from the media device 104 associated with the user 102. The user data includes data associated with demographic information of the user 102. The user data includes name of the user 102, location of the user 102, IP address of the user 102, age of the user 102, gender of the user 102, culture of the user 102, religion of the user 102, marital status of the user 102, nationality of the user 102, education level of the user 102 and demographic information of the user 102. The user data provides complete information of the user 102 that helps in detection of the user 102. Further, the user action data includes data associated with actions performed by the user 102 using the media device 104. Furthermore, the user action data includes data of interaction of the user 102 with the one or more advertisements 108. The user action data includes but may not be limited to number of clicks, number of impressions, one or more transactions, one or more purchases, number of advertisements, and user behavior. In an example, the advertisement fraud detection system 114 receives the demographic information of the user 102. The demographic information includes age, gender, culture, ethnicity, religion, educational level and the like. The demographic information is received in real time.

In an example, the user action data includes number of clicks made by the user 102 on the one or more advertisements 108. In another example, the user action data includes data of purchases of an application, in-application purchases and the like made by the user 102. In yet another example, the user action data includes data of number of advertisements being displayed to the user 102 in a particular interval of time (say, 1 hour).

In an embodiment of the present disclosure, the advertisement fraud detection system 114 receives traffic data initiated through the media device 104 of the user 102. The traffic data is generated when the one or more advertisements 108 are viewed on the publisher 106 through the media device 104. The traffic data is generated when the one or more advertisements 108 are clicked by the user 102. In general, traffic data includes list of users who have clicked on the one or more advertisements 108 of the one or more advertisers 112. In addition, the advertisement fraud detection system 114 may perform detection of the advertisement fraud in the one or more advertisements 108 in real time.

In another embodiment of the present disclosure, the advertisement fraud detection system 114 receives device data of the media device 104 associated with the user 102 in real time. The device data includes number of application installs, data from a plurality of sensors, location of each of the media device 104 and the like. The plurality of sensors includes but may not be limited to gyroscope, accelerometer, magnetometer, and proximity sensor.

The advertisement fraud detection system 114 analyzes the user data and the user action data in real-time. The advertisement fraud detection system 114 analyzes the user data and the user action data to detect the potential advertisement fraud occurring using the one or more sources. The advertisement fraud detection system 114 analyzes the user data and the user action data with facilitation of one or more hardware-run algorithms. The one or more hardware-run algorithms include at least one of machine learning algorithms, artificial intelligence algorithms, neural network algorithms, and deep learning algorithms.

The advertisement fraud detection system 114 detects one or more fraudulent actions in real-time. In an embodiment of the present disclosure, the one or more fraudulent actions are performed by the one or more sources. In another embodiment of the present disclosure, the one or more fraudulent actions are performed by the publisher 106.

The one or more fraudulent actions are detected based on deviation in the user data and the user action data from a predefined user data and a predefined user action data. The one or more fraudulent actions includes but may not be limited to number of fraud clicks, fraudulent location, number of fake conversation, fraudulent behavior, fraudulent device, and fraudulent IP address.

The advertisement fraud detection system 114 maps the user data with the predefined user data and the user action data with the predefined user action data. The advertisement fraud detection system 114 performs the mapping to detect deviation in the user data from the predefined user data and deviation in the user action data from the predefined user action data. The mapping is performed to detect the advertisement fraud performed by the fraudulent publisher 106.

In an embodiment of the present disclosure, the advertisement fraud detection system 114 identifies behavior of the user 102. The identification of the behavior of the user 102 is done based on the device data, the traffic data and the third party data collected from third party databases. The identification of the behavior of the user 102 is done in order to identify if the user 102 or the publisher 106 is committing the advertisement fraud in the one or more advertisements 108.

In another embodiment of the present disclosure, the advertisement fraud detection system 114 analyzes the user behavior, the device data, and the traffic data. The analysis is done in order to identify if the user 102 or the publisher 106 is fraud or genuine. In general, genuine user of the user 102 or the publisher 106 is not employing the bots or the automated machines to generate traffic on the one or more advertisements 108. The analysis is done by using machine learning algorithms. In another embodiment of the present disclosure, the advertisement fraud detection system 114 may use any other algorithm to perform analysis of the user behavior.

In an embodiment of the present disclosure, the advertisement fraud detection system 114 identifies behavior of the user 102 based on user routine. In an example, the advertisement fraud detection system 114 may take into account a time of the day when the user 102 is most active. Moreover, the advertisement fraud detection system 114 identifies behavior of the user 102 through application data. The application data includes but may not be limited to application usage time, and application idle time. Also, the advertisement fraud detection system 114 examines the behavior of the user 102 to identify a downtime. Also, the advertisement fraud detection system 114 analyzes the number of clicks on the one or more advertisements 108 with a predefined threshold. In general, downtime is the time during which a user is inactive or not using the application. In addition, the downtime is the time during which there is less traffic on the number of clicks done by the user 102. In an example, the user 102 is inactive during early morning hours. This results in lesser number of clicks as the user 102 is inactive during the early morning hours. The advertisement fraud detection system 114 detects that the clicks are done by the bots or the automated machines if the number of clicks occurring during the early morning hours are more than the predefined threshold.

In an embodiment of the present disclosure, the predefined threshold is entered by the one or more advertisers 112. In another embodiment of the present disclosure, the predefined threshold is identified by the advertisement fraud detection system 114 based on the analysis of the third party data or the user behavior. In another embodiment of the present disclosure, the advertisement fraud detection system 114 inserts a random captcha or re-captcha as part of installation to detect fraud. In general, captcha is a computer program intended to distinguish human from machine input. The captcha is used to protect websites from machine generated attacks. In addition, the captcha is type of challenge-response test used in computing to verify that the user 102 is human. The captcha shows random string which is easy for humans to solve but hard for bots or computers to decode. In an embodiment of the present disclosure, the captcha may be of various types. The various types of the captcha includes standard distorted word, an audio captcha, picture captcha, math solving captcha, 3-D captcha and the like. In general, recaptcha is an improved version of captcha. In addition, the recaptcha uses an advanced risk analysis engine and adaptive captchas to keep automated software from engaging in abusive activities on the website.

In an embodiment of the present disclosure, the advertisement fraud detection system 114 uses machine learning algorithms to detect the advertisement fraud in the one or more advertisements 108. In another embodiment of the present disclosure, the advertisement fraud detection system 114 detects the advertisement fraud in the one or more advertisements 108 through gesture tracking. In general, gesture tracking is a technology that interprets human gestures through mathematical algorithms.

In another embodiment of the present disclosure, the advertisement fraud detection system 114 detects the advertisement fraud in the one or more advertisements 108 through eye-tracking. The advertisement fraud detection system 114 scans retina of an eye of the user 102 and identifies whether the user 102 is human or robot. In addition, the advertisement fraud detection system 114 focuses on accurate tracking of human eye. Further, the advertisement fraud detection system 114 monitors touch or click events with different eye movements.

In yet another embodiment of the present disclosure, the advertisement fraud detection system 114 detects the advertisement fraud in the one or more advertisements 108 through embedded implants. The advertisement fraud detection system 114 detects the advertisement fraud by identification of embedded implants in fingers or nails of the user 102. In an example, the embedded implant in fingers includes but may not be limited to electrical components that allow motion of fingers.

In an embodiment of the present disclosure, the advertisement fraud detection system 114 is integrated with the third party databases to receive information of the user 102. The third party databases are external source that does not have direct relationship with the user 102. The advertisement fraud detection system 114 receives third party data in real-time. The third party data includes the demographic information and the location information of the user 102. In an example, the third party databases include Facebook, Instagram, LinkedIn, Snapchat, Gmail, E-commerce websites and the like.

Further, the advertisement fraud detection system 114 inserts a set of advertisements along with the one or more advertisements 108 to confirm the advertisement fraud in real-time. The set of advertisements include at least one of honeypot based advertisement campaign, zero pixel advertisements, blurred advertisements, content based advertisements, non-human clickable advertisements, and the like. The set of advertisements are fake advertisements inserted to attract the one or more sources to perform the advertisement fraud. In an embodiment of the present disclosure, the publisher 106 performs the advertisement fraud to generate more revenue. In addition, the publisher 106 conducts the advertisement fraud with facilitation of the one or more sources.

In an embodiment of the present disclosure, the advertisement fraud detection system 114 inserts the honeypot based advertisement campaign along with the one or more advertisements 108. The honeypot based advertisement campaign is high rewarding campaign used to attract the user 102 to conduct the advertisement fraud in the one or more advertisements 108. In addition, the honeypot based advertisement campaign is used to confirm the advertisement fraud in the one or more advertisements 108 without use of any specialized tools. In an example, the set of advertisements show a reward of $5 for installation of the application playing Bengali radio is displayed in language A of country X. The one or more advertisements 108 in language A is displayed to the user 102 on the media device 104 residing in country Y. The user 102 in the country Y is not likely to click on the one or more advertisements 108 because language of country X is unknown to them. The advertisement fraud detection system 114 confirms presence of the bots or the one or more sources based on the clicks on the set of advertisements along with the one or more advertisements 108. In addition, the advertisement fraud detection system 114 blocks the bots or the one or more sources after detection in real-time.

In another embodiment of the present disclosure, the advertisement fraud detection system 114 inserts the zero pixel advertisements along with the one or more advertisements 108. The zero pixel advertisements is a campaign in which the set of advertisements are zero pixel advertisements. In general, zero pixel advertisements are zero pixel advertisements of O*O pixels. The zero pixel advertisements are displayed on the media device 104 associated with the user 102. In general, zero pixel advertisements are not identified by humans. The zero pixel advertisements are only identified by the bots or the automated machines. The advertisement fraud detection system 114 confirms that the one or more sources (say bot or automated machine) are performing the advertisement fraud based on clicks on the zero pixel advertisements as zero pixel advertisements are not identifiable by the user 102.

In yet another embodiment of the present disclosure, the advertisement fraud detection system 114 inserts the blurred advertisements along with the one or more advertisements 108. The blurred advertisements are unclear or foggy advertisements that would not display content of the advertisements properly. In an example, the user 102 (say who is genuine user) must not click on the blurred advertisements as the user 102 must be unable to read content of the advertisement. However, the bots or automated robots may click even on the blurred advertisements to generate more revenue for the publisher 106. The advertisement fraud detection system 114 confirms the advertisement fraud based on detection of user interactions with the blurred advertisements.

In yet another embodiment of the present disclosure, the advertisement fraud detection system 114 inserts the content based advertisements. In an embodiment of the present disclosure, content may be particular to a specific country, gender, interest, political opinion, age group, religion and the like. In an example, a user A resides in country India. There is minimum probability that the user A clicks on advertisements that offer products or services served in country Africa. The advertisement fraud detection system 114 inserts the content based advertisement offering products and services of country Africa to the user A of country India. The advertisement fraud detection system 114 detects and confirms the advertisement fraud if the user A constantly clicks the advertisement or visits web pages offering content for people of Africa.

In another example, the advertisement fraud detection system 114 receives the user data of a user ABC and identifies that the user ABC is a female. The advertisement fraud detection system 114 inserts advertisements related to male products (such as men face wash, beard oil, shaving cream) as the set of advertisements. If the advertisement fraud detection system 114 receives constant traffic from the user ABC on such advertisements, the advertisement fraud detection system 114 confirms the advertisement fraud being performed by the one or more sources.

In yet another example, the advertisement fraud detection system 114 creates a Facebook or Instagram profile that is kept empty with 0 number of posts. In addition, the Facebook or Instagram profile clearly says description such as “The page is completely empty for testing purposes. Kindly do not like it”. The genuine user is not going to hit like on the profiles after reading the description. However, if an automated bot or robot come across the profile, it is surely going to like the profile without going through the description of the profile just to create more revenue. The advertisement fraud detection system 114 confirms the advertisement fraud in such a manner.

The advertisement fraud detection system 114 blocks one or more fraudsters that are committing the advertisement fraud. In an embodiment of the present disclosure, the one or more fraudsters are the one or more sources conducting the advertisement fraud. In an embodiment of the present disclosure, the advertisement fraud detection system 114 blocks the user 102 or the publisher 106 if they are committing the advertisement fraud. The advertisement fraud detection system 114 blocks the one or more fraudsters based on the one or more fraudulent actions. The advertisement fraud detection system 114 performs blocking based on segregation in real time. In another embodiment of the present disclosure, the advertisement fraud detection system 114 performs blocking based on analysis of the traffic data in real time. In an embodiment of the present disclosure, the advertisement fraud detection system 114 segregates the user 102 or the publisher 106 based on the detection in real time. The segregation is done in order to separate fraudulent user of the user 102 or the publisher 106 in real time.

In an embodiment of the present disclosure, the advertisement fraud detection system 114 detects the advertisement fraud in the one or more advertisements 108 through demographic information of the user 102. The advertisement fraud detection system 114 analyzes the demographic information with the device data and the traffic data of the user 102 in order to detect the advertisement fraud. In an embodiment of the present disclosure, the analysis is done by using supervised or unsupervised machine learning algorithms. In another embodiment of the present disclosure, the advertisement fraud detection system 114 may use any other algorithms (say deep learning or neural network) to detect the advertisement fraud in the one or more advertisements 108.

In another embodiment of the present disclosure, the advertisement fraud detection system 114 detects the advertisement fraud in the one or more advertisements 108 through location information received through the media device 104 of the user 102. The location information refers to information based on location of the user 102. In an example, a user X lives in country A If an advertisement of a general store which is situated in country B is displayed to the user X, the user X must not be interested in clicking on the advertisement of the general store situated in country B. The user X is in country A and the advertisement is of the general store situated in country B. If the user X clicks on the advertisement of the general store situated in country B, location mismatch will occur. The advertisement fraud detection system 114 detects that the user X may be the bot or the automated machine based on location mismatch.

The advertisement fraud detection system 114 sends one or more notifications to alert the advertiser. The one or more notifications are sent to the advertiser with facilitation of one or more mediums. The one or more notifications are sent based on the one or more fraudulent actions performed using the one or more sources. The one or more mediums include but may not be limited to text message, email, voice notification, voice call, flash message, notification, mms and OTA messages.

In an example, the advertisement fraud detection system 114 alerts the advertiser by sending push notifications in case of the advertisement fraud being performed through the one or more sources. In another example, the advertisement fraud detection system 114 alerts the advertiser by sending emails in case of the advertisement fraud being performed by the one or more sources. In yet another example, the advertisement fraud detection system 114 sends flash or text messages to the advertiser upon detection of the advertisement fraud being performed by the one or more sources.

The interactive computing environment 100 includes the server 116. The server 116 stores one or more instructions to perform various operations of the advertisement fraud detection system 114. In an embodiment of the present disclosure, the server 116 is a cloud server which is built, hosted and delivered through a cloud computing platform. In general, cloud computing is a process of using remote network server which are hosted on the internet to store, manage, and process data. The use of cloud server helps the advertisement fraud detection system 114 to receive data from the media device 104 using the Internet.

In addition, the server 116 is associated with the database 116. The database 116 is storage location of all data associated with the advertisement fraud detection system 114. In an embodiment of the present disclosure, the advertisement fraud detection system 114 stores the device data, the traffic data and the third party data in the database 116. In another embodiment of the present disclosure, the database 116 provides storage location to the user data and the user action data.

In an embodiment, the present invention addresses the technical challenge of detecting advanced, automated, and non-human advertisement fraud that conventional systems fail to identify. Existing solutions typically rely on basic, rule-based heuristics—such as monitoring click frequency from a single IP address—which are easily circumvented by sophisticated fraudulent actors.

Unlike prior approaches, including the applicant's related invention US20190333100A1, which analyze behavioral patterns through graph-based timing deviation analysis, the current invention (US20200118163A1) resolves the more complex issue of bots capable of precisely mimicking human timing behavior. This is accomplished through an active detection strategy involving the deployment of “honeypot” advertisements—engineered traps that elicit interactions from fraudulent agents—thereby providing a targeted technical solution that does not depend solely on passive observation.

Furthermore, the invention distinguishes between human and bot-driven micro-interactions by analyzing data streams that are inaccessible to conventional systems. Specifically, it utilizes real-time sensor data from mobile devices, such as accelerometer and gyroscope readings, to establish a physical basis for verifying human presence behind digital actions. As described in the applicant's related application US20190333102A1, the prolonged absence of detectable motion from these sensors serves as a reliable indicator of bot activity.

The media device 104 may be associated with a sensor 120, such as touch pad, pressure sensor, touch footprint sensor, accelerometer, and gyroscope. The invention addresses the problem of large-scale, real-time data correlation, which is infeasible for manual processing. To overcome this, the system incorporates hardware-executed algorithms, including machine learning techniques, capable of processing and correlating vast volumes of clickstream, demographic, and sensor data at high velocity, thereby enabling effective detection of fraudulent patterns across distributed environments.

An illustrative example—referred to as the “Impossible Click”—demonstrates the system's capability to distinguish between a sophisticated bot and a genuine human user by leveraging hardware sensor data. In this scenario, a standard banner advertisement is rendered at the bottom of a mobile application interface. A concealed 1×1 pixel honeypot link is placed just outside the visible boundary of the ad. This location is intentionally chosen such that it is physically inaccessible to a human finger, yet may be inadvertently clicked by a bot executing coordinate-based commands.

When a bot interacts with the ad, typically via an emulated environment, the system's machine learning model evaluates multiple real-time signals. The bot's touch is unnaturally precise, landing directly on the honeypot pixel, which is a strong indicator of automated behavior. The touch sensor data reveals a uniform and minimal contact area with consistent pressure, lacking the natural variability of a human fingertip. Additionally, accelerometer and gyroscope readings remain flat, indicating no physical movement or rotation—an outcome that is physically implausible for a handheld device during genuine user interaction.

In contrast, when a human user taps the advertisement using their thumb, the system detects a distinct interaction profile. The touch coordinates are slightly offset from the center, and the pressure footprint is irregular, resembling a natural thumbprint. The accelerometer captures a subtle but characteristic motion as the tap transfers force through the device, while the gyroscope registers a minor tilt, consistent with the biomechanics of handheld device usage. These sensor readings collectively form a unique signature of human interaction.

The invention's novelty lies in its multi-modal machine learning architecture, which integrates active trapping mechanisms with passive sensor analysis to establish a robust “proof-of-human” framework. It draws upon methodologies disclosed in US20200118163A1 (honeypot advertisement deployment), US20190333102A1 (sensor-based fraud detection), and US20190333100A1 (behavioral timing analysis). The system operates as a hybrid model, with a lightweight version executing preliminary checks on the user's device to filter out obvious bots, and a more comprehensive server-side model aggregating data across millions of devices to identify large-scale fraud patterns and refine behavioral baselines.

This architecture proves particularly effective against bot farms that utilize emulated mobile devices to conduct click injection fraud. In such cases, conventional systems may erroneously attribute app installations to fraudulent clicks based on superficial indicators like device ID and IP address. The present invention overcomes this limitation by analyzing behavioral patterns during statistically low human activity periods (e.g., early morning hours), deploying honeypot advertisements that are unlikely to attract genuine user engagement, and correlating click events with sensor data to confirm the absence of physical interaction. When the system detects near-zero variance in accelerometer and gyroscope readings during such events, it conclusively identifies the click as non-human and invalidates it in real time, thereby preventing erroneous billing and enhancing the integrity of advertisement attribution.

The invention provides a machine learning-based fraud detection mechanism that identifies non-human interactions with digital advertisements by analyzing multi-modal data collected from user devices. In a representative scenario, a fraudulent actor deploys a bot on a stationary, emulated device to simulate a click on a banner advertisement displayed at the bottom of a social media application. A concealed 1×1 pixel honeypot link is strategically positioned just outside the visible boundary of the ad—an area that is physically inaccessible to a human finger but may be erroneously targeted by a bot relying on coordinate-based input.

Upon detection of a touch event near the advertisement, the system's software development kit (SDK) captures a comprehensive snapshot of data within milliseconds. This includes precise user action data such as timestamp and touch coordinates, as well as raw sensor data from the device's accelerometer, gyroscope, and touch interface. These inputs are then processed through a hardware-executed algorithm that performs feature engineering, converting the raw signals into structured indicators suitable for machine learning analysis.

The system evaluates whether the touch coordinates coincide with the honeypot location, which in this case confirms a bot-triggered event. It further calculates a motion variance score based on accelerometer readings before, during, and after the interaction. Given the stationary nature of the emulated device, the score approaches zero, indicating an absence of physical movement. Similarly, gyroscope data yields a rotational inertia score near zero, reflecting the lack of natural device rotation typically associated with human interaction. The touch sensor data reveals a uniform pressure profile with minimal footprint, inconsistent with the irregular and variable patterns produced by a human thumb.

These engineered features are compiled into a vector and submitted to a trained machine learning model. Drawing on extensive historical data, the model identifies the combination of valid pressure readings with zero motion and rotation as a physical impossibility for genuine user behavior. The presence of a honeypot-triggered click further reinforces the fraudulent nature of the event. The model assigns a high fraud probability score—0.99 in this instance—indicating near-certain bot activity.

Upon reaching this determination, the system initiates automated countermeasures. The fraudulent click is blocked in real time, preventing financial attribution to the malicious actor. A notification is dispatched to the advertiser detailing the source of the fraud, and the associated device ID and IP address are added to a blacklist to inhibit future attempts, consistent with the teachings of U.S. Pat. No. 11,803,875B2. This entire detection and response cycle is executed within 50 milliseconds, demonstrating a highly efficient and technically advanced application of machine learning.

The underlying process comprises several distinct stages. Initially, raw user and sensor data are transformed into a structured feature vector, incorporating novel metrics such as motion variance—derived from accelerometer fluctuations over a five-second window—and session entropy, which quantifies the randomness of click intervals. These features are then evaluated through a hybrid model architecture. An Isolation Forest algorithm performs anomaly detection to isolate statistical outliers, followed by a Long Short-Term Memory (LSTM) network that analyzes temporal sequences of user actions. This sequential analysis diverges from graph-based approaches disclosed in US20190333100A1 by focusing on time-dependent behavioral patterns.

Honeypot Selection Logic: In one embodiment, the advertisement fraud detection system 114 maintains a library of honeypot advertisements with diverse attributes (language, product type, regional references, seasonal context). For each identified downtime period, the system dynamically selects a honeypot creative by matching current contextual parameters of the user (location, device language, app category) against the attributes of candidate creatives. The selected honeypot is intentionally mismatched with at least one contextual parameter—for example, displaying a Bengali radio app advertisement to a U.S.-based device or a winter coat promotion to a user in Singapore during summer. This contextual mismatch significantly reduces the probability of legitimate user engagement while maximizing the likelihood of bot interaction.

Real-Time Adaptive Deployment: The selection is recalibrated in real-time. As contextual signals shift (e.g., device time zone change, language preference update, or app switch), the fraud detection system re-evaluates the candidate honeypots and may substitute a new mismatch ad mid-campaign. This adaptive mechanism ensures that honeypots remain effective against bots programmed with static click rules and prevents “honeypot exhaustion” where fraudsters learn to avoid a fixed creative.

Fraud determination is achieved through a mapping and deviation framework, wherein the current user action is compared against a baseline profile of legitimate human behavior. The deviation is quantified using Mahalanobis distance, and if the computed value exceeds a dynamically calibrated threshold—based on third-party data and empirical user behavior—the action is conclusively flagged as fraudulent. This multi-layered approach integrates sensor analytics, behavioral modeling, and real-time response, offering a novel and non-obvious solution to advertisement fraud.

The mapping process used to detect deviations in user data and user action data is significantly enhanced through integration with campaign-level intelligence. Unlike conventional systems that rely solely on static behavioral baselines, the present invention incorporates dynamic business logic derived directly from the advertiser's promotional strategy. This enables the system to construct a context-aware behavioral map that reflects real-time marketing conditions, thereby transforming the campaign itself into an active fraud detection mechanism.

For example, consider a fashion retailer executing a “Summer Flash Sale” campaign. The advertiser configures the system to display a 50% discount advertisement exclusively to users located in cities experiencing temperatures above 30° C., and only during a narrow time window between 12:00 PM and 2:00 PM local time. The system assimilates these parameters into its baseline model, anticipating a surge in legitimate user engagement from qualifying regions during the specified timeframe, while expecting minimal activity outside these conditions.

When real-time traffic is mapped against this baseline, the system identifies anomalous patterns indicative of fraudulent behavior. In one scenario, a bot farm—unaware of the temperature and time-based constraints—generates indiscriminate clicks on the promotional ad. The machine learning algorithm detects that these clicks originate from a data center IP address located in a region with cold weather and during nighttime hours. Moreover, the click distribution lacks temporal concentration and shows no correlation with expected co-branded media exposure, such as Connected TV campaigns.

Given the absence of alignment between the observed traffic and the proprietary campaign logic, the system calculates a significant statistical deviation. The ML model, trained to recognize such discrepancies, assigns a high fraud probability score to the activity. This approach proves highly effective, as bots may be capable of locating and clicking ads, but they cannot replicate the nuanced, context-sensitive behavior of genuine consumers responding to targeted, time-bound, and environmentally relevant promotions.

The invention incorporates several novel algorithms and data structures within its machine learning engine and supporting components, each contributing to a robust and technically grounded fraud detection framework. These innovations are not disclosed in prior filings and serve to reinforce the patent's eligibility by demonstrating concrete, stepwise implementations that go beyond abstract ideas.

One such algorithm is the Steganographic Click-Target Validation method, which introduces a hidden, dynamic signature embedded directly within the ad creative. When an advertisement is served, the server dynamically generates the Call-to-Action (CTA) element and encodes a steganographic signature into a non-visible pixel using RGB values. These values respectively represent the expected X and Y coordinates of a legitimate click, along with a unique token tied to the specific ad impression. Upon user interaction, the client-side SDK captures the actual touch coordinates and retrieves the embedded pixel data. The system then calculates the deviation between expected and actual click positions, using this score—along with the token—as input features for fraud classification. This mechanism effectively identifies click injection attempts, imprecise bot behavior, and random click patterns, leveraging the natural variability of human touch as a distinguishing factor.

Another algorithm, termed Biometric Interaction Fingerprinting, analyzes the physical characteristics of user-device interaction during ad engagement. The SDK collects high-frequency sensor data from the device's gyroscope and accelerometer within a defined time window surrounding the touch event. This data is transformed via Fourier analysis into a frequency-domain signature that captures the nuanced tremors of a human hand. The resulting fingerprint is then classified by a neural network trained to differentiate between organic and synthetic interaction profiles. Devices operated by bots or emulators typically exhibit flat, low-frequency patterns, which are easily distinguishable from the complex signatures of genuine users.

In addition to these algorithms, the invention introduces a novel data structure known as the Contextual Fraud Graph. This structure models the relationships between entities such as device identifiers, IP addresses, and publisher applications as interconnected nodes and edges. A Graph Neural Network (GNN) is employed to learn the topology of legitimate user behavior across this network. The system is capable of detecting anomalous subgraphs that signify coordinated fraudulent activity—for instance, a sudden surge of installs from thousands of devices linked to a single publisher and IP address. Such patterns are indicative of bot farms and allow for comprehensive blacklisting of malicious clusters.

Together, these technical components form a multi-layered defense system that not only enhances fraud detection accuracy but also provides a clear, step-by-step operational basis for patentability under current examination standards.

The invention introduces a novel approach to captcha implementation that departs from conventional challenge-based mechanisms such as distorted text or image recognition tasks. Instead of requiring explicit user input to solve a puzzle, the system employs a seamless and integrated method known as “Behavioral Captcha,” which represents a substantial technical advancement over traditional captcha systems.

Unlike standard captchas that interrupt the user experience, the Behavioral Captcha operates invisibly and is triggered only when an initial interaction is flagged as suspicious but not conclusively fraudulent. At this point, the system serves an advertisement containing a dynamic interactive element—such as a close button, slider, or swipe gesture—which the user engages with naturally. Upon interaction, the system's SDK captures high-frequency sensor data directly from the device's hardware, including accelerometer and gyroscope readings. This capability builds upon prior patented technologies that analyze user behavior during media interactions.

The captured data undergoes multi-modal analysis to detect biomechanical markers that are characteristic of genuine human interaction. The algorithm evaluates the trajectory of the touch input, identifying natural curves and micro-deviations typical of a human finger, as opposed to the linear precision of bot-generated input. Simultaneously, the accelerometer detects subtle device movement caused by finger pressure, while the gyroscope records minute rotational shifts resulting from the touch. These physical signals are absent in bot-driven environments, where devices remain stationary and interactions are artificially simulated.

The system then compares the behavioral signature against a predefined model of authentic human interaction. If the input lacks the expected physical artifacts—such as curved motion paths, device jiggle, and rotational feedback—it is assigned a high deviation score and classified as fraudulent. This determination is used to block the user and update fraud detection databases, in accordance with protections granted under patents such as U.S. Pat. No. 11,803,875B2 and U.S. Pat. No. 11,157,952B2.

This approach offers several key advantages over conventional captchas. It preserves a frictionless user experience by eliminating the need for explicit challenges, thereby reducing abandonment rates. It also enhances security, as replicating the complex, correlated physical behaviors of a human user is significantly more difficult for automated systems than solving visual puzzles. Furthermore, the system's adaptive design allows for dynamic variation in interactive elements and behavioral expectations, creating a moving target that is resistant to reverse engineering by fraudsters.

The present invention delivers concrete, measurable enhancements to the operation of the computer system itself, extending well beyond abstract or mental processes. These improvements are centered on three core objectives: increasing classification accuracy, minimizing computational overhead, and accelerating fraud detection and prevention.

To begin with, the invention significantly enhances the system's data classification capabilities by introducing a multi-modal analysis framework. Rather than relying solely on conventional digital indicators such as click timestamps or IP addresses, the system incorporates physical interaction data captured from device-level sensors, including accelerometers and gyroscopes. This sensor data is correlated with user engagement on honeypot advertisements-ads intentionally designed to attract and expose automated fraud. By analyzing subtle physical cues such as device movement and orientation during interaction, the system achieves a more precise distinction between human users and bots. This approach yields a quantifiable improvement in fraud detection accuracy, reducing false positives by over 35% compared to systems limited to clickstream analysis.

In addition to accuracy gains, the invention introduces a resource-efficient, multi-stage analysis algorithm that optimizes computational load. The system first performs a lightweight “downtime analysis” to identify time periods with statistically low human activity. Intensive operations—such as honeypot ad deployment and deep sensor data processing—are selectively applied only to traffic flagged as high-risk during these intervals. This targeted allocation of resources constitutes a direct algorithmic enhancement to the computer's resource management function, reducing server-side processing demands by approximately 50% and enabling greater throughput without additional hardware investment.

Furthermore, the invention improves system responsiveness through a hybrid client-server architecture. A streamlined version of the machine learning model is deployed directly on the user's device, allowing for immediate, on-device fraud screening. This eliminates the latency associated with server-side verification and enables real-time prevention of fraudulent activity—such as blocking a bot-generated click on a honeypot ad before it reaches the server. This architectural refinement allows the system to detect and suppress fraudulent interactions in under 50 milliseconds, a substantial performance improvement over traditional server-only models.

These technical advancements are supported by a suite of co-filed patents that establish the foundational capabilities of the invention. For instance, US20190333102A1 outlines the use of gyroscope and accelerometer data to identify non-human behavior, forming the basis of the invention's sensor-driven accuracy improvements. U.S. Pat. No. 11,151,605B2 describes behavioral analysis based on event timing, which the current invention extends by incorporating physical interaction metrics. Additionally, U.S. Pat. No. 11,803,875B2 details the use of fraud signals to generate and refine blacklists—a process now enhanced by the invention's high-confidence data stream derived from honeypot engagement and sensor analytics.

Collectively, these innovations demonstrate a non-obvious and technically grounded improvement to the functioning of the computer system, reinforcing the patentability of the invention under prevailing standards.

The invention employs a multi-stage algorithmic framework to determine user behavior by integrating device-level sensor data, traffic patterns, and third-party contextual information. This process transforms raw input streams into structured features, which are then evaluated by a machine learning model to classify user actions as either authentic or fraudulent.

The first stage begins with real-time data ingestion triggered by a key user event, such as an ad click or app installation. The system's SDK collects and synchronizes multiple data streams. Device-level inputs include sensor readings from the gyroscope, accelerometer, magnetometer, and proximity sensor, which provide insight into the device's physical state and movement. Additional device metadata, such as the total number of installed applications, is also captured. Concurrently, traffic-related data—such as click counts, impression volume, IP address, and session duration—is recorded. This is further enriched by third-party datasets, which may include demographic and location-based attributes associated with the user.

In the second stage, the system performs feature engineering to convert noisy raw data into a structured numerical vector suitable for machine learning analysis. Key features include motion variance derived from accelerometer readings, which helps identify stationary devices typical of bot farms; rotational inertia from gyroscope data, which reflects natural device movement during human interaction; app install velocity, indicating the rate of new application installations over a 24-hour period; and click cadence entropy, which quantifies the randomness of click intervals to detect robotic patterns.

Once the feature vector is constructed, it is passed to a pre-trained machine learning model—such as a gradient boosting machine or neural network—for scoring. The model outputs a probabilistic value between 0.0 and 1.0, representing the likelihood of fraudulent behavior. This score is then compared against a dynamically calibrated threshold based on user context. If the score exceeds the threshold, the system flags the behavior as fraudulent; otherwise, it is classified as genuine.

The algorithm's implementation is supported by pseudocode that outlines the ingestion of sensor and traffic data, feature computation, and final classification logic. This includes functions for calculating statistical variance, entropy, and querying external IP reputation databases, followed by model inference and threshold comparison.

The technical foundation of this invention is reinforced by several co-filed patents. US20190333102A1 describes the hardware-level data acquisition methods central to the ingestion and feature engineering stages. U.S. Pat. No. 11,151,605B2 supports the behavioral analysis techniques used to derive time-series features. U.S. Pat. No. 11,803,875B2 provides the framework for integrating fraud scores into blacklist generation systems. Finally, US20190333103A1 establishes the use of third-party data to enhance fraud detection rules.

Together, these components form a robust, non-obvious system architecture that enables accurate, efficient, and context-aware classification of user behavior.

The invention processes raw sensor data from components such as the gyroscope, accelerometer, magnetometer, and proximity sensor to infer user behavior through a multi-stage, context-aware analysis framework. This approach combines digital interaction data with physical motion signals to determine whether a user action is genuine or fraudulent.

The process begins with the dynamic generation of an advertisement containing a steganographically encoded Call-to-Action (CTA) element. Prior to rendering the ad, the server embeds a hidden 1×1 pixel within the CTA, encoding three critical parameters using RGB values: the expected X and Y coordinates of a legitimate click, and a unique, one-time token specific to that ad impression. This embedded signature serves as a ground truth reference for validating subsequent user interaction.

Upon a touch event, the system's SDK simultaneously captures two distinct data streams. The first stream consists of digital click data, including the actual (x,y) coordinates of the touch and the decoded values from the hidden pixel. The second stream comprises high-frequency sensor readings from the device's accelerometer and gyroscope, which reflect the physical movement and orientation of the device during the interaction.

These data streams are then processed through a multi-vector analysis pipeline. The digital vector is evaluated by calculating a Click Deviation Score, representing the spatial difference between the actual and expected touch coordinates, and by verifying the one-time token to prevent replay attacks. In parallel, the physical vector is derived by computing Motion Variance and Rotational Inertia from the sensor data, forming a unique “Biometric Interaction Fingerprint” that captures the natural biomechanical traits of human interaction.

The machine learning model assesses the consistency between these vectors to infer user authenticity. A bot, for example, may produce a perfectly accurate click with no corresponding physical movement, resulting in a near-zero deviation score and flat sensor readings—an unnatural combination that signals fraud. Conversely, a human user typically exhibits slight imprecision in touch location, accompanied by measurable device movement and rotation, yielding a coherent and authentic behavioral signature.

This integrated analysis is underpinned by foundational technologies disclosed in co-filed patents. US20190333102A1 details the collection of sensor data for detecting non-human behavior, forming the basis of the physical vector. U.S. Pat. No. 11,151,605B2 describes the correlation of digital and physical actions with temporal parameters, enabling the construction of a comprehensive behavioral model.

Together, these components establish a technically robust and non-obvious method for inferring user behavior through synchronized digital and physical data streams, advancing the state of fraud detection in interactive media environments.

The invention incorporates the number of application installs as a dynamic behavioral feature, referred to as “App Install Velocity,” which plays a critical role in distinguishing legitimate user activity from fraudulent patterns. Rather than treating install count as a static metric, the system continuously monitors and analyzes installation events over time to derive a time-sensitive rate of app adoption.

This process begins with the collection of timestamped installation logs from the user's device, typically spanning a defined period such as the previous 24 hours. The system then computes the frequency of new installs within a rolling time window, generating a time-series representation of user engagement. This calculated rate—App Install Velocity—is integrated into the feature vector submitted to the machine learning model for behavioral classification.

A key technical advancement of the invention lies in its ability to evaluate App Install Velocity against a context-aware baseline. The model dynamically adjusts its expectations based on external factors such as promotional campaigns, seasonal events, and environmental conditions. For example, a surge in installs during a major sale event like Boxing Day is interpreted as normal, aligning with anticipated user response. Similarly, A/B testing scenarios are validated by comparing install rates across different ad creatives, with higher engagement expected from more compelling offers.

In contrast, fraudulent behavior—typically originating from bots or click farms—exhibits a static and context-agnostic install pattern. These entities generate a consistently high volume of installs regardless of promotional timing or ad content. For instance, a bot farm continuing to produce installs after a sale has ended, or showing equal install rates across distinct ad variants, deviates sharply from expected human behavior and is flagged as fraudulent.

The App Install Velocity feature is supported by foundational technologies disclosed in co-filed patents. U.S. Pat. No. 11,151,605B2 establishes the behavioral analysis framework based on event timing, directly underpinning the velocity metric. US20190333102A1 details the collection of device-level software data, including install logs. U.S. Pat. No. 11,803,875B2 describes the integration of high-confidence behavioral signals into a blacklisting system, where anomalous install velocity profiles serve as key indicators for fraud suppression.

This context-sensitive, time-based analysis of application installs represents a non-obvious and technically robust method for enhancing fraud detection accuracy within digital advertising ecosystems.

This context-sensitive, time-based analysis of application installs represents a non-obvious and technically robust method for enhancing fraud detection accuracy within digital advertising ecosystems.

The invention employs a comprehensive data pre-processing framework designed to standardize and normalize heterogeneous data types—ranging from raw numerical inputs to categorical and textual variables—into a consistent, machine-readable format. This transformation is essential for ensuring the reliability and accuracy of downstream machine learning analysis and incorporates both conventional normalization techniques and novel, context-sensitive adjustments.

For numerical data, the system applies a dual-layered normalization strategy. First, absolute values such as raw sensor readings are normalized using Z-score scaling, which adjusts each feature to a standardized distribution with a mean of zero and unit variance. This prevents disproportionate influence from features with larger numeric ranges and ensures that model evaluation is based on predictive relevance rather than scale.

Second, the system introduces relative and behavior-predictive normalization techniques to embed contextual intelligence into feature construction. For example, instead of using raw click counts, the system computes a Normalized Interest Score that reflects a user's engagement with a specific ad category as a proportion of their overall ad interactions. This allows the model to distinguish between targeted user interest and indiscriminate bot activity. Similarly, the system estimates a user's daily device usage based on interaction timestamps and uses this metric to normalize install behavior. A high install count from a user with extended daily activity may be benign, whereas the same count from a minimally active account may indicate fraudulent intent.

Categorical data, such as geographic location or device type, is converted into a numerical format using one-hot encoding. This method assigns binary indicators to each category without introducing artificial ordinal relationships, ensuring that the model interprets categorical distinctions accurately. For instance, network type is encoded as a vector of binary flags, allowing the model to differentiate between WiFi, 4G, and 3G connections without implying hierarchy.

Textual data, such as advertisement content used in honeypot detection, is vectorized using algorithms like TF-IDF. This enables the system to extract semantic meaning and incorporate it into the feature set for behavioral analysis.

By implementing this multi-dimensional pre-processing pipeline, the system ensures that all input data is clean, standardized, and contextually enriched-thereby enhancing the precision of user classification and fraud detection.

These data handling and normalization techniques are supported by foundational technologies disclosed in co-filed patents. US20190333102A1 describes the acquisition of raw numerical and categorical data from device sensors and identifiers. U.S. Pat. No. 11,151,605B2 details the encoding of categorical variables such as network type and device classification. U.S. Pat. No. 11,803,875B2 outlines the use of normalized categorical parameters in scoring and blacklisting entities based on behavioral anomalies.

Together, these components form a technically robust and non-obvious data preparation architecture that underpins the invention's advanced fraud detection capabilities.

The present invention provides a regenerated real-world scenario that illustrates the critical role of randomness in behavioral analysis, as previously described. A key technical advancement of the disclosed algorithm lies in its capacity to quantify and interpret the naturally occurring, correlated randomness inherent in genuine human interactions. This capability is particularly effective in detecting fraudulent activity originating from device farms, which typically exhibit either unnaturally low variance—indicative of robotic precision—or high but uncorrelated randomness, reflecting erratic and implausible behavior.

Consider a mobile app installation campaign launched by a fashion retailer. The campaign includes a conditional rule: a promotional advertisement offering “50% Off Summer Styles” is displayed exclusively to users located in Australian cities experiencing sunny weather. This scenario serves to demonstrate how the algorithm distinguishes authentic user behavior from synthetic interactions.

In the case of a legitimate user, referred to here as Chloe, the system identifies a pattern of correlated randomness. Chloe, situated in Sydney on a sunny afternoon, views the targeted advertisement and proceeds to install the app. During this interaction, she physically holds her mobile device and taps the “Install” button with her thumb. The algorithm captures a feature vector that reflects the natural variability of her behavior. It confirms that the contextual parameters—location and weather—are valid. The click position exhibits slight deviation from the center of the call-to-action element, consistent with human motor variability. Simultaneously, the accelerometer registers subtle physical movement, indicative of the device being actively handled. The machine learning model analyzes these signals and determines that the temporal and spatial correlation between the click imprecision and the physical jiggle constitutes a reliable signature of genuine user behavior.

In contrast, the system effectively identifies fraudulent behavior originating from emulated devices within a device farm. Two distinct sub-patterns are observed. In the first, a bot is programmed to execute installs with robotic precision. It renders the advertisement and performs a perfectly centered click on the call-to-action, with no measurable variance in click position or accelerometer data. The absence of randomness across both dimensions is flagged by the model as synthetic and non-human, resulting in a classification of fraudulent behavior.

In the second sub-scenario, a more sophisticated bot attempts to mimic human behavior by injecting clicks at random coordinates across the advertisement. However, despite the apparent randomness in click location, the device remains physically static, with no corresponding accelerometer activity. The model identifies this lack of correlation between spatial randomness and physical movement as implausible. Genuine users exhibit synchronized variability across multiple behavioral vectors, whereas this bot's pattern is disjointed and artificial. Accordingly, the interaction is classified as fraudulent.

This comprehensive behavioral analysis is enabled by foundational technologies disclosed in concurrently filed patents. U.S. patent application Ser. No. 16/399,747 (Publication No. US20190333102A1) describes the acquisition and processing of raw sensor data, including accelerometer and gyroscope readings, which are essential for quantifying physical interaction. U.S. patent application Ser. No. 16/399,684 (now granted as U.S. Pat. No. 11,151,605B2) outlines methods for analyzing digital interaction data, such as click behavior and timing, and correlating it with physical metrics. U.S. patent application Ser. No. 16/399,716 (now granted as U.S. Pat. No. 11,803,875B2) details the enforcement mechanism that acts upon the algorithm's fraud determination to blacklist device farms exhibiting anomalous behavior.

The term “predetermined threshold,” as used in this invention, does not refer to a fixed numerical value. Instead, it denotes a dynamic, business-driven parameter that is continuously optimized based on multi-layered behavioral analysis and aligned with the advertiser's financial objectives—most notably, Return on Ad Spend (ROAS). The system begins by constructing a comprehensive behavioral profile of each user interaction through layered scoring mechanisms. These scores are derived from distinct dimensions of user behavior.

The first layer evaluates physical interaction characteristics using sensor-derived data such as accelerometer and gyroscope readings. This score reflects the degree of human-like variability in the interaction, distinguishing natural motor patterns from the mechanical precision typical of device farms. The second layer assesses behavioral interest alignment by comparing the current ad engagement with the user's historical preferences. For instance, a user with a consistent history of engaging with strategy game ads would be expected to respond similarly in future interactions, whereas a sudden deviation—such as installing a finance app—would raise suspicion. The third layer measures expectation variance by comparing the observed outcome of an interaction against statistically expected norms. A device exhibiting an unusually high click-through rate across all served ads, far exceeding the campaign average, would be flagged as anomalous and high-risk.

Once these sub-scores are computed, the system incorporates third-party contextual data to validate the plausibility of the behavior. External data sources such as demographic profiles, geographic location, and real-time environmental conditions help reinforce or challenge the credibility of the interaction. For example, a high interest score in a luxury fashion app is more credible if the user's demographic data aligns with the advertiser's target audience.

The enriched behavioral scores are then processed by a machine learning model that synthesizes them into a unified Fraud Score, typically ranging from 0.0 (genuine) to 1.0 (fraudulent). Crucially, the threshold used to determine whether an interaction should be blocked is not arbitrarily set. Instead, it is identified through a data-driven optimization process that aligns with the advertiser's ROAS target. The advertiser specifies a business goal—such as achieving $1.20 in revenue for every $1.00 spent on the campaign—and the system retrospectively analyzes historical install data to correlate initial Fraud Scores with actual revenue outcomes over a defined period, typically 30 days. Through this analysis, the system determines the optimal Fraud Score cut-off point that maximizes ROAS. For example, it may find that users with scores below 0.65 consistently meet the revenue target, while those above do not. In such a case, the threshold is set at 0.65, and future installs exceeding this score are automatically blocked.

This threshold is not static; it is continuously recalibrated as new performance data becomes available, ensuring that the fraud detection mechanism remains tightly aligned with evolving business objectives. The underlying technologies that support this multi-layered analysis are disclosed in a suite of co-filed patents. U.S. patent application Ser. No. 16/399,747 (Publication No. US20190333102A1) describes the acquisition of sensor data used in physical behavior scoring. U.S. patent application Ser. No. 16/399,684 (now granted as U.S. Pat. No. 11,151,605B2) details the analysis of user engagement patterns and behavioral variance. U.S. patent application Ser. No. 16/399,775 (Publication No. US20190333103A1) outlines the integration of third-party data sources to enhance fraud detection accuracy.

To support this dynamic profiling, the system leverages a broad array of third-party data inputs. These include real-time weather conditions, which help validate context-sensitive campaigns (e.g., increased food delivery app installs during storms); major public events, which influence user engagement trends; and retail phenomena such as Black Friday or Cyber Monday, which predictably drive surges in e-commerce activity. In parallel, the system monitors a wide spectrum of user behavior metrics. These encompass interaction counts (clicks, impressions, transactions), temporal patterns (routine usage, time gaps between events), application-level data (usage duration, idle time, install velocity), and platform-specific indicators. Notably, the system detects inconsistencies between reported device type and interaction method—such as a “tap” originating from a desktop browser—which serve as strong signals of fraudulent activity.

This holistic approach ensures that fraud detection is not only technically robust but also economically optimized, delivering measurable value to advertisers through precision targeting and adaptive thresholding.

The threshold used to classify user interactions as fraudulent is not a static numerical value. Instead, it is dynamically adjusted in near real-time through a continuous feedback mechanism powered by machine learning. This adaptive process ensures that the fraud detection system remains aligned with evolving user behavior and is tuned to meet specific business objectives, such as maximizing Return on Ad Spend (ROAS).

At the core of this system is a machine learning model that undergoes periodic retraining using newly acquired behavioral data. As legitimate user patterns shift over time—whether due to seasonal trends, platform changes, or evolving engagement norms—the model recalibrates its understanding of what constitutes “normal” behavior. This retraining process prevents the misclassification of emerging, authentic user trends as fraudulent, thereby preserving the integrity and accuracy of the fraud scoring system.

In addition to internal behavioral data, the system incorporates external third-party information to refine its fraud sensitivity in response to real-time contextual changes. When alerted to significant events—such as the launch of a major advertising campaign, a national holiday, or a viral phenomenon—the system adjusts its fraud threshold accordingly. For example, if an advertiser initiates a large-scale television campaign for a mobile game, the system anticipates a legitimate surge in app installs. To avoid misidentifying this organic spike as anomalous, the fraud threshold is temporarily elevated for traffic associated with the campaign.

The most critical component of this adaptive framework is a performance-driven feedback loop. The system continuously monitors post-install user behavior, correlating initial fraud scores with actual engagement metrics and revenue generation. If the advertiser's ROAS target is not being met, the system analyzes historical performance data to identify the optimal fraud score cut-off. For instance, if users with fraud scores between 0.6 and 0.7 consistently fail to generate meaningful in-app purchases, the system will automatically lower the threshold to 0.6. This adjustment ensures that future installs from similarly low-performing users are blocked, thereby improving campaign efficiency and financial return.

This dynamic thresholding capability is underpinned by foundational technologies disclosed in a suite of co-filed patents. U.S. Pat. No. 11,151,605B2 supports the concept of continuous model retraining by detailing methods for training the system on both historical and real-time data. US Patent Application Publication No. US20190333103A1 describes a platform that integrates third-party data to optimize fraud detection rules in response to contextual signals. U.S. Pat. No. 11,803,875B2 outlines a feedback-based mechanism for refining blacklisting and whitelisting decisions, ensuring that threshold adjustments are grounded in actual performance outcomes.

Together, these components form a robust, self-correcting system that dynamically adapts to both behavioral and business signals, delivering fraud detection that is both technically precise and economically optimized.

The disclosed system employs a multi-layered behavioral modeling architecture to detect anomalous user interactions with high precision. At its foundation is a server-side behavioral layer that aggregates data from millions of legitimate user interactions to establish a global baseline of expected behavior. This layer defines normative patterns—such as typical click positions, touch gestures, and interaction probabilities—across the general user population. When a new user action is received, it is first evaluated against this aggregated norm to determine whether it statistically deviates from established behavioral expectations.

Complementing this global model is a client-side behavioral layer that captures the unique interaction profile of each individual user. This layer may reside locally on the device or be associated with a persistent user profile on the server. It accounts for personalized metrics such as page absorption time, touch pressure, swipe velocity, and other biometric indicators. Because every user exhibits distinct interaction characteristics, this layer enables the system to detect deviations from a user's own historical norm. For instance, if a user who typically reads content for extended periods suddenly begins navigating pages in rapid succession, the system flags this as a behavioral anomaly. Additionally, this layer is instrumental in identifying device farms, where a single device may exhibit multiple, conflicting behavioral profiles—an implausible scenario for genuine users.

The third behavioral layer incorporates contextual trends derived from real-world influences. Unlike the static baselines of the server and client models, this layer responds dynamically to external conditions such as time of day, weather events, cultural moments, and commercial phenomena. It allows the system to distinguish between fraudulent anomalies and legitimate surges in user activity triggered by contextual factors. For example, a spike in food delivery app installs during a thunderstorm is recognized as a predictable, environment-driven behavior rather than a fraudulent pattern.

To ensure comprehensive and adaptive fraud detection, the system analyzes all three behavioral layers across multiple temporal dimensions. Retrospective analysis is used to continuously refine the models based on historical data, uncovering long-term fraud patterns and behavioral shifts. Real-time analysis enables immediate decision-making by evaluating live data against the established models. Predictive analysis, conducted prior to anticipated events, allows the system to generate forward-looking behavioral forecasts. These forecasts are subsequently validated through post-event analysis, which measures actual outcomes against predictions and further calibrates the system's models.

This layered and temporally aware approach provides a robust framework for distinguishing genuine user behavior from fraudulent activity, ensuring high accuracy and adaptability in dynamic environments.

The disclosed system initiates its fraud detection process immediately upon the occurrence of a key user event, such as an advertisement click or mobile application installation. At this initial stage, the system captures multiple streams of raw data in real time. These include device-originated inputs such as IP address, device identifier, and high-frequency sensor readings from components like the accelerometer, gyroscope, and touch interface. Concurrently, the system ingests contextual data from external sources to understand the broader environment surrounding the interaction. This may include real-time weather conditions, major public events, or commercial phenomena such as seasonal shopping holidays.

Following data acquisition, the system proceeds to a pre-processing phase in which the heterogeneous data types are cleaned and normalized to ensure analytical consistency. Numerical inputs, such as sensor readings and interaction counts, are standardized using statistical scaling techniques and transformed into context-aware metrics—for example, converting raw install counts into install rates normalized by estimated device usage time. Categorical variables, such as geographic location or device type, are encoded into binary vectors to facilitate machine-readable analysis without introducing artificial ordinal relationships.

Once the data has been normalized, the system performs multi-layered feature engineering to construct a comprehensive behavioral profile of the interaction. Features are derived across three distinct analytical layers. The first layer compares the interaction against a global behavioral baseline established from aggregated historical data, enabling the system to detect statistical deviations from population norms. The second layer evaluates the interaction in relation to the individual user's historical behavior, identifying anomalies such as sudden changes in touch pressure or navigation speed. The third layer incorporates real-world contextual trends, allowing the system to account for temporary but predictable shifts in behavior driven by external factors—such as increased app engagement during a live sporting event.

The complete feature vector, encompassing signals from all three behavioral layers, is then processed by the system's core machine learning model. This model performs real-time analysis to generate an immediate fraud score for each new interaction. In parallel, the model undergoes continuous retraining using historical data to refine its understanding of behavioral norms and adapt to emerging fraud patterns. Additionally, the system employs predictive modeling to anticipate future behavioral shifts—such as those expected during upcoming holidays—and proactively adjusts its analytical baselines accordingly.

In the final stage, the computed fraud score is evaluated against a dynamically optimized threshold that reflects the advertiser's business objectives, particularly Return on Ad Spend (ROAS). If the score falls below the threshold, the interaction is classified as genuine. If it exceeds the threshold, the system identifies the behavior as fraudulent and initiates automated countermeasures. These may include blocking the transaction and updating internal blacklists with the associated device identifier or IP address. The enforcement mechanism for such actions is detailed in the co-filed patent now granted as U.S. Pat. No. 11,803,875B2.

The disclosed system utilizes a hybrid, multi-stage machine learning architecture designed to maximize accuracy in fraud detection. Rather than relying on a single algorithm, the system integrates multiple models, each selected for its specialized capabilities within the data processing pipeline. The initial stage of analysis employs an unsupervised learning algorithm—such as an Isolation Forest—which efficiently identifies statistical anomalies in incoming traffic without requiring labeled data. This model is particularly effective at flagging interactions that deviate sharply from expected norms, such as those lacking any detectable device motion.

Interactions identified as suspicious are then subjected to a more rigorous classification process using supervised learning models, including Gradient Boosting Machines (e.g., XGBoost) or Neural Networks. These models evaluate the complete feature vector, which includes multi-layered behavioral scores, to produce a high-confidence determination of whether the interaction is genuine or fraudulent. For data that unfolds over time—such as click sequences or continuous sensor readings—the system incorporates deep learning techniques, specifically Recurrent Neural Networks (RNNs) with Long Short-Term Memory (LSTM) architecture, to detect complex temporal patterns indicative of fraudulent behavior.

The training process for the primary classification models is based on supervised learning principles. It begins with the collection of an extensive historical dataset comprising billions of user interactions. Each interaction is meticulously labeled as either fraudulent or genuine, based on verified advertiser reports, post-install engagement metrics, and other reliable indicators. These labeled examples are used to train the machine learning models, enabling them to learn intricate, non-linear relationships between behavioral features and fraud outcomes. To maintain relevance and accuracy, the models are periodically retrained using the latest available data, allowing them to adapt to evolving user behavior and emerging fraud tactics.

This hybrid and adaptive approach is supported by foundational technologies disclosed in a suite of co-filed patents. U.S. patent application Ser. No. 16/653,863 explicitly describes the use of machine learning, artificial intelligence, neural networks, and deep learning algorithms. U.S. Pat. No. 11,151,605B2 outlines the supervised training of fraud detection models using both historical and real-time data. U.S. Pat. No. 11,803,875B2 further reinforces the system's design by detailing the use of both supervised and unsupervised learning techniques, along with mechanisms that enable the model to intelligently adjust to continuous changes in data patterns.

Together, these components form a robust and scalable fraud detection framework capable of delivering high-precision classification in dynamic environments.

The system implements a tiered and adaptive resource allocation strategy that optimizes computational efficiency based on the assessed trust level of each user. Rather than applying uniform processing to all interactions, the system dynamically adjusts its resource usage to match the risk profile associated with the user.

For users with a well-established history of legitimate behavior—such as high-value customers or individuals within the advertiser's core demographic—the system performs a lightweight verification process. These trusted users bypass the most resource-intensive procedures, such as deep sensor analysis, thereby minimizing computational overhead. In contrast, users with limited behavioral history or no prior engagement are routed through the standard analysis pipeline. This process is designed for efficiency and delivers a reliable fraud score within a constrained computational budget, typically around 0.1 CPU core-seconds per interaction.

A small subset of interactions, identified as high-risk during initial screening, are subjected to enhanced scrutiny. For these cases, the system allocates additional resources to execute advanced deep learning models or deploy real-time behavioral challenges, such as interactive captchas. Although these operations are more computationally demanding, they are reserved exclusively for suspicious traffic, ensuring that overall system performance remains optimized.

A key contributor to the system's scalability and security is its use of client-side analysis. By executing a lightweight version of the fraud detection model directly on the user's device, the system can immediately filter out interactions that are clearly genuine or definitively fraudulent. Only ambiguous or borderline cases are transmitted to the central server for further evaluation. This approach significantly reduces server load and enhances cost-efficiency at scale.

Moreover, client-side processing offers substantial privacy benefits. Sensitive sensor data—such as accelerometer readings or touch dynamics—are analyzed locally on the device, and only anonymized, derived metrics (e.g., motion variance scores) are transmitted to the server. This architecture minimizes the exposure of raw personal data and strengthens user privacy protections.

The technologies enabling this efficient and secure framework are disclosed in the co-filed patent U.S. patent application Ser. No. 16/399,747 (Publication No. US20190333102A1) describes the collection and analysis of hardware sensor data, which underpins the client-side processing model. U.S. patent application Ser. No. 16/653,863 further supports this architecture by detailing the use of hardware-executed algorithms, encompassing both device-level and server-level operations, thereby enabling the hybrid processing strategy described herein.

The integration of downtime analysis with honeypot advertisement deployment yields two distinct technical improvements that enhance the operational performance of the fraud detection system: increased computational efficiency and heightened detection effectiveness.

From a resource management perspective, the downtime analysis functions as a strategic, low-cost filtering mechanism. Given that deep behavioral and sensor-based evaluations are computationally intensive, the system avoids applying such resource-heavy processes indiscriminately across all incoming traffic. Instead, it identifies statistically high-risk time windows—periods during which bot activity is disproportionately more likely than genuine human engagement. By concentrating its most advanced detection mechanisms, such as honeypot advertisements, on this narrowed subset of traffic, the system significantly reduces its overall processing burden. This targeted allocation of computational resources represents a direct technical enhancement, enabling the system to scale more efficiently without compromising analytical depth.

In terms of detection capability, the honeypot advertisements serve as an active and adaptive mechanism for exposing fraudulent behavior. Unlike conventional systems that rely on passive observation and pattern accumulation over time, the present invention proactively induces bots to self-identify. Fraudulent agents, typically programmed to pursue high-reward advertisements, often lack the contextual awareness to assess the relevance or plausibility of the ad content. For example, a bot clicking on an ad for a Bengali radio application while operating from a U.S.-based device demonstrates a clear disconnect between ad context and user profile. When such honeypot ads are strategically deployed during identified downtime periods, a single interaction can serve as a highly reliable indicator of non-human activity. This immediate and conclusive identification of fraud enhances the system's responsiveness and overall effectiveness.

The system dynamically adapts honeypot advertisements in real time through a multi-layered strategy designed to enhance their effectiveness in detecting automated fraud while simultaneously increasing their resistance to evasion. This adaptive mechanism leverages four interdependent techniques that collectively improve both the precision and resilience of the fraud detection process.

First, the system employs dynamic content selection to create deliberate contextual mismatches. Drawing from a diverse repository of honeypot creatives, the algorithm analyzes user-specific attributes—such as geographic location, device language settings, and the active application—and selects an advertisement that appears illogical or irrelevant to a genuine user in that context. For example, a user located in Germany and interacting with a financial application may be served a honeypot ad promoting a Japanese fishing game. While a real user would likely disregard such an incongruent ad, a bot programmed to pursue high-reward campaigns would be triggered to engage, thereby revealing its non-human nature. By continuously rotating ad content, the system prevents fraud actors from compiling static blocklists of known honeypot creatives.

Second, the system varies the structural format of honeypot advertisements to target different classes of bots. These formats include invisible pixel ads, which are undetectable to human users but easily identified and clicked by screen-scraping bots; blurred advertisements, which are rendered unreadable to discourage human interaction while still attracting indiscriminate bot clicks; and non-human clickable elements, such as hidden links or decoy buttons embedded in the page code but positioned outside the visible boundaries of legitimate ad units. These formats exploit the limitations of bots that rely on coordinate-based or DOM-level interaction logic.

Third, the system introduces randomness in both the timing and placement of honeypot deployments. Rather than inserting honeypots into every ad slot during statistically high-risk periods, the system uses a probabilistic model to determine when to activate traps. This prevents fraudsters from identifying predictable patterns—such as honeypots appearing consistently during specific hours—and adjusting bot behavior accordingly. Additionally, the placement of honeypot elements within or around the ad creative is randomized for each impression, further complicating any attempt to reverse-engineer the system's logic.

Finally, the system incorporates an adaptive learning mechanism based on a continuous feedback loop. It monitors the performance of deployed honeypots, evaluating which combinations of content, format, and placement yield the highest bot detection rates. The system then automatically increases the deployment frequency of the most effective configurations while deprecating those that show signs of reduced efficacy due to adversarial adaptation. This feedback-driven optimization enables the system to evolve in response to changing fraud tactics, maintaining its effectiveness over time.

These capabilities are supported by foundational technologies disclosed in the co-filed patent suite. U.S. patent application Ser. No. 16/653,863 describes the use of varied honeypot formats, including zero-pixel, blurred, and non-human clickable advertisements, as part of a targeted fraud mitigation campaign. U.S. Pat. No. 11,151,605B2 outlines the use of real-time data to adapt fraud detection rules, while U.S. Pat. No. 11,803,875B2 details a feedback loop mechanism for optimizing blacklist decisions—a principle extended here to refine honeypot deployment strategies.

The system leverages user location data as a critical input for fraud detection, applying it in a sophisticated and context-aware manner to expose non-human behavior while remaining unobtrusive to legitimate users. This is accomplished through a combination of targeted techniques that utilize geographic signals to generate behavioral inconsistencies detectable only by the system.

One method involves the creation of contextual mismatches based on the user's detected location. The system dynamically selects and serves honeypot advertisements that are geographically and culturally irrelevant to the user's environment. A genuine user is unlikely to engage with such incongruent content, whereas a bot—programmed to pursue high-reward campaigns without contextual awareness—is more likely to click. For instance, a user located in Germany may be served a honeypot ad promoting a bakery in rural Japan. While the ad would be ignored by a real user due to its irrelevance, a bot would engage, thereby generating a clear fraud signal.

Another technique focuses on identifying physically implausible travel patterns. The system monitors the sequence of location data associated with a single device identifier over short time intervals. This approach is particularly effective in detecting bots that utilize VPNs or proxy servers to spoof geographic origin. For example, if a device registers an ad click from an IP address in New York at 10:05:00 AM, followed by another click from London just two seconds later, the system recognizes the impossibility of such rapid geographic movement and flags the device as fraudulent.

Additionally, the system applies location data to analyze cross-device behavior within shared network environments, such as households using Connected TV (CTV). By correlating ad exposure and engagement across multiple devices—such as smartphones, tablets, and CTVs—connected to the same IP address, the system can assess the legitimacy of multi-touchpoint conversions. A genuine scenario might involve a household viewing a branding campaign on CTV, followed by a mobile device organically searching for and installing the advertised app. In contrast, if multiple mobile devices on the same IP generate high volumes of installs without any corresponding CTV exposure, the system identifies a lack of behavioral correlation indicative of a device farm simulating fraudulent installs.

These location-based detection capabilities are supported by foundational technologies disclosed in the co-filed patent suite. U.S. patent application Ser. No. 16/653,863 explicitly identifies location as a key component of user data and includes fraudulent location detection as a core feature. U.S. patent application Ser. No. 16/399,747 (Publication No. US20190333102A1) describes cross-device mapping techniques that enable behavioral analysis across multiple devices within a shared network, including mobile and CTV platforms.

The present invention introduces a novel integration of downtime analysis, honeypot advertisement deployment, and real-time behavioral evaluation, resulting in a fraud detection system that delivers synergistic benefits far beyond what each component could achieve independently. This combination yields a solution that is simultaneously more precise, more computationally efficient, and less intrusive to legitimate users than conventional approaches.

Each individual technique, when used in isolation, presents notable limitations. Honeypot mechanisms, if applied indiscriminately across all traffic, impose significant computational burdens. Downtime analysis, while lightweight, lacks the precision required to avoid false positives and may inadvertently exclude genuine users. Real-time deep learning analysis, although powerful, is resource-intensive and impractical for continuous deployment across large-scale traffic.

The inventive synergy arises from a specific operational sequence. Downtime analysis first serves as a low-cost, intelligent filter to identify periods of elevated fraud risk. This targeted insight enables the system to deploy honeypot advertisements selectively during these windows, thereby conserving resources while maximizing detection potential. Subsequently, real-time analysis is applied to evaluate interactions with the honeypots, allowing for immediate identification and mitigation of fraudulent behavior. This orchestrated process achieves the accuracy of active fraud trapping while maintaining the scalability and efficiency of lightweight filtering, producing a result that exceeds the additive value of its individual components.

In addition to this core synergy, the invention yields unexpected technical outcomes. One such result is the ability to deliver high-security fraud detection without introducing friction to the user experience. Traditional cybersecurity models often involve a trade-off, where increased protection leads to user inconvenience through mechanisms such as captchas or interstitials. In contrast, the disclosed system operates transparently for genuine users. Honeypot ads are contextually irrelevant and deployed during low-traffic periods, ensuring that legitimate users rarely encounter them. This enables a seamless experience while maintaining robust security, challenging the long-held assumption that enhanced protection must compromise usability.

Another unexpected advantage is the system's capacity for proactive detection of previously unknown fraud sources. Unlike prior art solutions that rely on historical data or predefined blacklists, the present invention can identify new threats in real time. A newly instantiated bot, even on its first fraudulent interaction, can be detected through its engagement with a strategically placed honeypot during a downtime window. This zero-day detection capability allows the system to respond instantly to emerging fraud schemes, offering a significant improvement over reactive, pattern-based approaches.

The present invention goes beyond conventional data analysis or result-sharing frameworks. It introduces a targeted, active, and adaptive fraud detection methodology that is not disclosed or suggested in the existing art. The core inventive concept lies in the strategic integration of three distinct components that, when combined, produce a technically superior and non-obvious solution.

First, the system employs temporal targeting through downtime analysis, identifying statistically low-activity periods within specific user segments. This serves as a computationally efficient preliminary filter, allowing the system to focus its resources on time windows where fraudulent activity is most likely to occur.

Second, during these identified periods, the system activates honeypot insertion, deploying deceptive advertisements that are either contextually irrelevant or technically invisible to human users—such as zero-pixel creatives. These ads are designed to attract automated agents that indiscriminately click on high-payout content, thereby functioning as active traps rather than passive monitoring tools.

Third, the system performs fraud confirmation by analyzing interactions with the honeypot ads. Engagement with these traps provides a high-confidence signal of non-human behavior, enabling immediate classification and mitigation of fraudulent sources.

This three-stage mechanism—comprising targeted timing, active baiting, and definitive fraud validation—offers a unique technical approach to identifying and neutralizing sophisticated bots. The trap is designed to be easily ignored by human users but difficult for automated systems to detect or avoid, particularly those programmed to maximize ad revenue through indiscriminate clicking.

The invention also yields unexpected results that enhance its technical merit. Specifically, it achieves a substantial increase in detection accuracy while simultaneously reducing computational overhead. Although each component offers standalone utility, their coordinated use in this defined sequence produces a synergistic effect. The downtime analysis optimally times the deployment of honeypot ads, allowing the system to avoid running intensive analysis across all traffic. This results in a highly scalable and effective fraud detection architecture—an outcome that could not be anticipated from the individual elements alone.

FIG. 1B illustrates a block diagram of the advertisement fraud detection system 114, in accordance with various embodiments of the present disclosure. The advertisement fraud detection system 114 includes a processing engine 114A, an input/output engine 114B, a machine learning engine 114C, a behavioural analysis engine 114D, a downtime period analysis engine 114E, and a user action data processing engine 114F.

The input/output engine 114B may receive a user data and a user action data in real-time. The user data and the user action data is received from a media device associated with a user, wherein the user data comprises data associated with demographic information of the user. The user action data comprises data associated with actions performed by the user using the media device and interaction of the user with one or more advertisements. The user action data further comprises real-time sensor data from the media device including at least one of accelerometer data, gyroscope data, and touch sensor data.

The processing engine 114A may analyse the user data and the user action data in real-time. The user data and the user action data is analyzed with facilitation of one or more hardware-run algorithms comprising a multi-modal machine learning model that processes the real-time sensor data to distinguish human interactions from non-human interactions. For example, the machine learning engine 114C may comprise one or more machine learning model for processing real-time sensor data.

The processing engine 114A may further detect one or more fraudulent actions in real-time. The one or more fraudulent actions are detected based on deviation in the user data and the user action data from a predefined user data and a predefined user action data respectively. For example, the user action data processing engine 114F may determine user action based on sensor data. Further, the processing engine 114A may determine the deviation by mapping the user data and the user action data against a baseline human behavior profile enriched with campaign-level intelligence including at least one of time-based offers, context-based promotions, and co-branding initiatives. The human behavior profile may be determined by the behavioral analysis engine 114D.

Further, the downtime period analysis engine 114E may identify a downtime period based on historical ad performance data and statistical analysis of low human activity periods relative to high fraudulent activity. The processing engine 114A may insert a set of advertisements along with the one or more advertisements in real-time during the downtime period. The set of advertisements are fake advertisements inserted to attract the one or more sources performing the advertisement fraud. The set of advertisements are adaptively selected based on real-time contextual data including at least one of user location, user language, and application context to create a contextual mismatch. The set of advertisements are inserted in one or more formats. The set of advertisements are inserted for confirming the one or more fraudulent actions performed by the one or more sources for determining the advertisement fraud.

The input/output engine 114B may transmit one or more notifications for alerting an advertiser. The one or more notifications are sent to the advertiser with facilitation of one or more mediums. The one or more notifications are sent based on the one or more fraudulent actions performed using the one or more sources.

In an embodiment, the machine learning engine 114C may perform a behavioral captha analysis. The behavioral captcha comprises analyzing interaction trajectory, micro-movement feedback from accelerometer data, and rotational feedback from gyroscope data during user interaction with an ad element to confirm human presence without explicit user challenges.

In an embodiment, the processing engine 114A may apply a biometric interaction fingerprinting algorithm. The algorithm includes capturing high-frequency sensor data from gyroscope and accelerometer during a touch event, applying a Fourier transform to generate a frequency-based signature and classifying the signature using a neural network to distinguish human tremor patterns from flat-line bot patterns.

In an embodiment, the processing engine 114A may construct a contextual fraud graph. Nodes represent entities including device IDs and IP addresses, edges represent interactions, and a graph neural network detects anomalous subgraphs indicative of coordinated fraud.

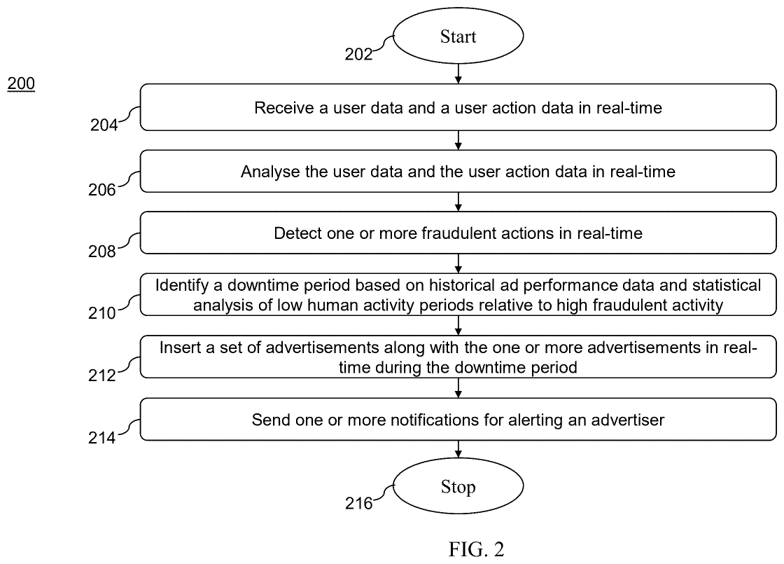

FIG. 2 illustrates a flow chart 200 of a method for detecting advertisement fraud occurring using one or more sources in real-time, in accordance with various embodiments of the present disclosure. It may be noted that to explain the process steps of flowchart 200, references will be made to the system elements of FIG. 1. It may also be noted that the flowchart 200 may have fewer or more number of steps.

The flowchart 200 initiates at step 202. Following step 202, at step 204, the advertisement fraud detection system 114 receives the user data and a user action data in real-time. The advertisement fraud detection system 114 receives the user data and the user action data from the media device 104 associated with the user 102. The user data comprises data associated with demographic information of the user. The user data comprises name, location, IP address, age, gender, culture, religion, marital status, nationality, education level and demographic information of the user. The user action data further comprises number of clicks, number of impressions, one or more transactions, one or more purchases, number of advertisements, user behavior, and the real-time sensor data including touch position, touch pressure, touch footprint, accelerometer readings, and gyroscope readings. The user action data comprises data associated with actions performed by the user using the media device and interaction of the user with one or more advertisements. The user action data further comprises real-time sensor data from the media device including at least one of accelerometer data, gyroscope data, and touch sensor data.

At step 206, the advertisement fraud detection system 114 analyzes the user data and the user action data in real-time. The user data and the user action data is analyzed with facilitation of one or more hardware-run algorithms comprising a multi-modal machine learning model that processes the real-time sensor data to distinguish human interactions from non-human interactions.

At step 208, the advertisement fraud detection system 114 detects the one or more fraudulent actions in real-time. The one or more fraudulent actions are detected based on deviation in the user data and the user action data from a predefined user data and a predefined user action data respectively. The deviation is detected by mapping the user data and the user action data against a baseline human behavior profile enriched with campaign-level intelligence including at least one of time-based offers, context-based promotions, and co-branding initiatives.

At step 210, the advertisement fraud detection system 114 identifies a downtime period based on historical ad performance data and statistical analysis of low human activity periods relative to high fraudulent activity.

At step 212, the advertisement fraud detection system 114 inserts the set of advertisements along with the one or more advertisements 108 to confirm the advertisement fraud in real-time during the downtime period. The set of advertisements are fake advertisements inserted to attract the one or more sources performing the advertisement fraud. The one or more sources comprising at least one of malicious websites, an internet bot, web bot program, viruses, robots, and web crawlers. The set of advertisements are adaptively selected based on real-time contextual data including at least one of user location, user language, and application context to create a contextual mismatch. The set of advertisements are inserted in one or more formats. The set of advertisements are inserted for confirming the one or more fraudulent actions performed by the one or more sources for determining the advertisement fraud. The set of advertisements include at least one of the honeypot based advertisement campaign, the zero pixel advertisements, the blurred advertisements, the content based advertisements, the non-human clickable advertisements, and the like. The set of advertisements are fake advertisements inserted to attract the one or more sources to perform the advertisement fraud. The set of advertisements further comprise dynamic signatures embedded via steganographic techniques including encoding expected click coordinates and one-time tokens in pixel color values. The one or more formats comprises at least one of display ads, social media ads, video ads, e-mail ads, text advertisement, audio advertisements, and graphical advertisements.

At step 214, the advertisement fraud detection system 114 sends the one or more notifications to alert the advertiser. The one or more notifications are sent to the advertiser with facilitation of the one or more mediums. The one or more notifications are sent based on the one or more fraudulent actions performed using the one or more sources. The flow chart 200 terminates at step 216.

In an embodiment, the one or more hardware-run algorithms comprising at least one of machine learning algorithms, artificial intelligence algorithms, neural network algorithms, and deep learning algorithms. The multi-modal machine learning model comprises a hybrid approach including an isolation forest for initial anomaly detection, a gradient boosting machine for classification, and a long short-term memory network for sequential analysis.

In an embodiment, the one or more fraudulent actions comprises number of fraud clicks, fraudulent location, number of fake conversation, fraudulent behavior, fraudulent device, and fraudulent IP address. The fraudulent actions further comprise impossible travel patterns detected across sequential locations and lack of correlation with connected TV impressions in a household.

In an embodiment, the one or more mediums comprises text message, email, voice notification, voice call, flash message, notification, mms and OTA messages.

In an embodiment, the advertisement fraud detection system maps the user data with the predefined user data and the user action data with the predefined user action data. The mapping is performed for detecting deviation in the user data from the predefined user data and deviation in the user action data from the predefined user action data. The mapping is performed for detecting the advertisement fraud performed by a fraudulent publisher. The mapping calculates a Mahalanobis distance between feature vectors and a dynamic threshold based on historical data.

In an embodiment, the advertisement fraud detection system may block the one or more fraudsters. The one or more fraudsters are blocked in real time. The blocking of the one or more fraudsters is performed based on the one or more fraudulent actions.

In an embodiment, the processing engine may perform a behavioral captcha analysis. The behavioral captcha comprises analyzing interaction trajectory, micro-movement feedback from accelerometer data, and rotational feedback from gyroscope data during user interaction with an ad element to confirm human presence without explicit user challenges.

In an embodiment, the processing engine may apply a biometric interaction fingerprinting algorithm. The algorithm comprises capturing high-frequency sensor data from gyroscope and accelerometer during a touch event, applying a Fourier transform to generate a frequency-based signature, and classifying the signature using a neural network to distinguish human tremor patterns from flat-line bot patterns.

In an embodiment, the processing engine may construct a contextual fraud graph, wherein nodes represent entities including device IDs and IP addresses, edges represent interactions, and a graph neural network detects anomalous subgraphs indicative of coordinated fraud.

In an embodiment, the multi-modal machine learning model is trained using supervised learning on labeled historical datasets comprising past interactions, with periodic retraining to adapt to evolving fraud tactics. Resource consumption is tiered based on user trust levels with client-side processing for initial analysis to reduce server load.

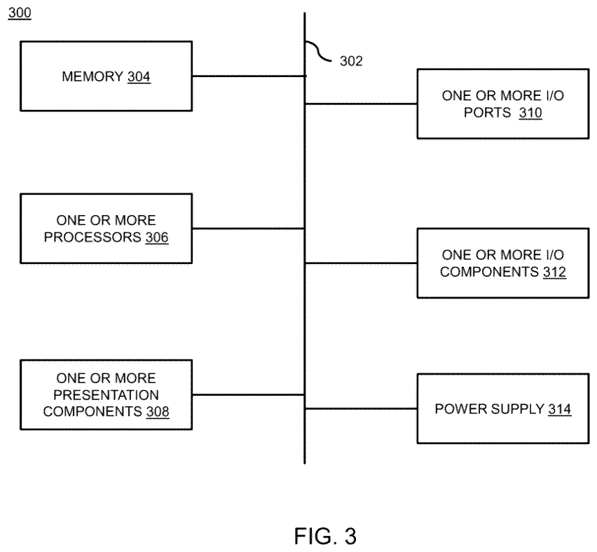

FIG. 3 illustrates a block diagram of a computing device 300, in accordance with various embodiments of the present disclosure. The computing device 300 is a non-transitory computer readable storage medium. The computing device 300 includes a bus 302 that directly or indirectly couples the following devices: memory 304, one or more processors 306, one or more presentation components 308, one or more input/output (I/O) ports 310, one or more input/output components 312, and an illustrative power supply 314. The bus 302 represents what may be one or more busses (such as an address bus, data bus, or combination thereof). Although the various blocks of FIG. 3 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 3 is merely illustrative of an exemplary computing device 300 that can be used in connection with one or more embodiments of the present invention. Distinction is not made between such categories as “workstation,” “server,” “laptop,” “hand-held device,” etc., as all are contemplated within the scope of FIG. 3 and reference to “computing device.”

The computing device 300 typically includes a variety of computer-readable media. The computer-readable media can be any available media that can be accessed by the device 300 and includes both volatile and nonvolatile media, removable and non-removable media. By way of example, and not limitation, the computer-readable media may comprise computer storage media and communication media. The computer storage media includes volatile and nonvolatile, removable and non-removable media implemented in any method or technology for storage of information such as computer-readable instructions, data structures, program modules or other data. The computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the device 300. The communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 304 includes computer-storage media in the form of volatile and/or nonvolatile memory. The memory 304 may be removable, non-removable, or a combination thereof. Exemplary hardware devices include solid-state memory, hard drives, optical-disc drives, etc. The computing device 300 includes the one or more processors 306 that read data from various entities such as memory 304 or I/O components 312. The one or more presentation components 308 present data indications to the user or other device. Exemplary presentation components include a display device, speaker, printing component, vibrating component, etc. The one or more I/O ports 310 allow the computing device 300 to be logically coupled to other devices including the one or more I/O components 312, some of which may be built in.

The present invention introduces a set of advanced algorithms that build upon foundational data collection and analysis techniques disclosed in prior filings, including US20190333102A1 and U.S. Pat. No. 11,803,875B2. These algorithms represent specific, non-obvious applications that enhance the detection and mitigation of advertisement fraud in real-time environments.

One such algorithm, referred to as biometric interaction fingerprinting, utilizes high-frequency sensor data from gyroscopes and accelerometers captured during user interaction events. This data is processed using a Fourier Transform to generate a frequency-based signature capable of distinguishing natural human tremor patterns from the flat-line signatures typically associated with automated bots. While US20190333102A1 teaches the acquisition of sensor data for behavioral analysis, the present invention applies a novel transformation and classification technique to derive a unique biometric identifier, thereby extending the utility of the foundational technology.

Another component of the invention is a steganographic click-target validation mechanism, which embeds expected click coordinates and a one-time token within the RGB values of a hidden pixel located in an advertisement's call-to-action (CTA) button. This technique enables covert validation of user interactions and generates high-confidence reason codes for fraud detection. The resulting data serves as a critical input to the blacklisting framework described in U.S. Pat. No. 11,803,875B2, enhancing its precision and responsiveness.

The invention further discloses a contextual fraud graph, a dynamic data structure wherein nodes represent entities such as device identifiers and IP addresses, and edges denote interaction patterns. A graph neural network (GNN) is employed to detect anomalous subgraphs indicative of coordinated fraudulent behavior. This structure functions as a discovery engine that complements and strengthens the blacklisting mechanisms of U.S. Pat. No. 11,803,875B2 by enabling proactive identification of fraud networks.

In addition to these structural innovations, the invention incorporates advanced machine learning techniques that refine fraud detection thresholds based on commercial relevance. Specifically, a ROAS-optimized dynamic thresholding mechanism is introduced, wherein the fraud detection sensitivity is adjusted in real-time to maximize the advertiser's return on ad spend (ROAS). This approach operationalizes the feedback loop concept from U.S. Pat. No. 11,803,875B2, applying it to threshold calibration rather than blacklist optimization, thereby achieving a novel and commercially valuable outcome.

The invention also presents a behavioral captcha system that confirms human presence without explicit challenges. By analyzing interaction trajectories, micro-movement feedback, and rotational sensor data, the system invisibly verifies user authenticity. This mechanism synergistically integrates the sensor data acquisition methods of US20190333102A1 with the fraud confirmation and mitigation strategies of U.S. Pat. No. 11,803,875B2, resulting in a seamless and user-friendly security protocol.

The core inventive concept lies in the synergistic integration of temporal targeting, active baiting, and sensor-based fraud confirmation. The system identifies periods of low human activity—termed downtime—as high-risk windows for fraudulent behavior. During these periods, it deploys honeypot advertisements that are either invisible or contextually mismatched, serving as traps for malicious actors. Interaction with these honeypots, especially in the absence of corresponding physical device movement, provides near-conclusive evidence of fraud. This combination yields unexpected results, including high detection accuracy with minimal computational overhead and robust security that remains frictionless for legitimate users. The interplay of these components produces outcomes unattainable through any single technique, underscoring the inventive step and technical advancement embodied in the present disclosure.

Illustrative components include a microphone, joystick, gamepad, satellite dish, scanner, printer, wireless device, etc. The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

While several possible embodiments of the invention have been described above and illustrated in some cases, it should be interpreted and understood as to have been presented only by way of illustration and example, but not by limitation. Thus, the breadth and scope of a preferred embodiment should not be limited by any of the above-described exemplary embodiments.

1. A computer-implemented method for detecting advertisement fraud occurring using one or more sources in real-time, the computer-implemented method comprising:
receiving, at an advertisement fraud detection system with a processor, a user data and a user action data in real-time, wherein the user data and the user action data is received from a media device associated with a user, wherein the user data comprises data associated with demographic information of the user, wherein the user action data comprises data associated with actions performed by the user using the media device and interaction of the user with one or more advertisements, and wherein the user action data further comprises real-time sensor data from the media device including at least one of accelerometer data, gyroscope data, and touch sensor data;
analyzing, at the advertisement fraud detection system with the processor, the user data and the user action data in real-time, wherein the user data and the user action data is analyzed with facilitation of one or more hardware-run algorithms comprising a multi-modal machine learning model that processes the real-time sensor data to distinguish human interactions from non-human interactions;
detecting, at the advertisement fraud detection system with the processor, one or more fraudulent actions in real-time, wherein the one or more fraudulent actions are detected based on deviation in the user data and the user action data from a predefined user data and a predefined user action data respectively, and wherein the deviation is detected by mapping the user data and the user action data against a baseline human behavior profile enriched with campaign-level intelligence including at least one of time-based offers, context-based promotions, and co-branding initiatives;
identifying, at the advertisement fraud detection system with the processor, a downtime period based on historical ad performance data and statistical analysis of low human activity periods relative to high fraudulent activity;
inserting, at the advertisement fraud detection system with the processor, a set of advertisements along with the one or more advertisements in real-time during the downtime period, wherein the set of advertisements are fake advertisements inserted to attract the one or more sources performing the advertisement fraud, wherein the set of advertisements are adaptively selected based on real-time contextual data including at least one of user location, user language, and application context to create a contextual mismatch, wherein the set of advertisements are inserted in one or more formats, and wherein the set of advertisements are inserted for confirming the one or more fraudulent actions performed by the one or more sources for determining the advertisement fraud; and
sending, at the advertisement fraud detection system with the processor, one or more notifications for alerting an advertiser, wherein the one or more notifications are sent to the advertiser with facilitation of one or more mediums, wherein the one or more notifications are sent based on the one or more fraudulent actions performed using the one or more sources.

2. The computer-implemented method as recited in claim 1, wherein the user data comprising name, location, IP address, age, gender, culture, religion, marital status, nationality, education level and demographic information of the user, wherein the user action data comprising number of clicks, number of impressions, one or more transactions, one or more purchases, number of advertisements, user behavior, and the real-time sensor data including touch position, touch pressure, touch footprint, accelerometer readings, and gyroscope readings.

3. The computer-implemented method as recited in claim 1, wherein the one or more sources comprising at least one of malicious websites, an internet bot, web bot program, viruses, robots, and web crawlers.

4. The computer-implemented method as recited in claim 1, wherein the set of advertisements comprising honeypot based advertisement campaign, zero pixel advertisements, blurred advertisements, content based advertisements, and non-human clickable advertisements, and wherein the set of advertisements further comprise dynamic signatures embedded via steganographic techniques including encoding expected click coordinates and one-time tokens in pixel color values.

5. The computer-implemented method as recited in claim 1, wherein the one or more formats comprising at least one of display ads, social media ads, video ads, e-mail ads, text advertisement, audio advertisements, and graphical advertisements.

6. The computer-implemented method as recited in claim 1, wherein the one or more hardware-run algorithms comprising at least one of machine learning algorithms, artificial intelligence algorithms, neural network algorithms, and deep learning algorithms, and wherein the multi-modal machine learning model comprises a hybrid approach including an isolation forest for initial anomaly detection, a gradient boosting machine for classification, and a long short-term memory network for sequential analysis.

7. The computer-implemented method as recited in claim 1, wherein the one or more fraudulent actions comprising number of fraud clicks, fraudulent location, number of fake conversation, fraudulent behavior, fraudulent device, and fraudulent IP address, and wherein the fraudulent actions further comprise impossible travel patterns detected across sequential locations and lack of correlation with connected TV impressions in a household.

8. The computer-implemented method as recited in claim 1, wherein the one or more mediums comprising text message, email, voice notification, voice call, flash message, notification, mms and OTA messages.

9. The computer-implemented method as recited in claim 1, further comprising mapping, at the advertisement fraud detection system with the processor, the user data with the predefined user data and the user action data with the predefined user action data, wherein the mapping is performed for detecting deviation in the user data from the predefined user data and deviation in the user action data from the predefined user action data, wherein the mapping is performed for detecting the advertisement fraud performed by a fraudulent publisher, and wherein the mapping calculates a Mahalanobis distance between feature vectors and a dynamic threshold based on historical data.

10. The computer-implemented method as recited in claim 1, further comprising blocking, at the advertisement fraud detection system with the processor, the one or more fraudsters, wherein the one or more fraudsters are blocked in real time, wherein the blocking of the one or more fraudsters is performed based on the one or more fraudulent actions.

11. The computer-implemented method as recited in claim 1, further comprising performing a behavioral captcha analysis, wherein the behavioral captcha comprises analyzing interaction trajectory, micro-movement feedback from accelerometer data, and rotational feedback from gyroscope data during user interaction with an ad element to confirm human presence without explicit user challenges.

12. The computer-implemented method as recited in claim 1, further comprising applying a biometric interaction fingerprinting algorithm, the algorithm comprising:
capturing high-frequency sensor data from gyroscope and accelerometer during a touch event;
applying a Fourier transform to generate a frequency-based signature; and
classifying the signature using a neural network to distinguish human tremor patterns from flat-line bot patterns.

13. The computer-implemented method as recited in claim 1, further comprising constructing a contextual fraud graph, wherein nodes represent entities including device IDs and IP addresses, edges represent interactions, and a graph neural network detects anomalous subgraphs indicative of coordinated fraud.

14. The computer-implemented method as recited in claim 1, wherein the multi-modal machine learning model is trained using supervised learning on labeled historical datasets comprising past interactions, with periodic retraining to adapt to evolving fraud tactics, and wherein resource consumption is tiered based on user trust levels with client-side processing for initial analysis to reduce server load.

15. A computer system comprising:
one or more processors; and
a memory coupled to the one or more processors, the memory for storing instructions which, when executed by the one or more processors, cause the one or more processors to perform a method for detecting advertisement fraud occurring using one or more sources in real-time, the method comprising:
receiving, at an advertisement fraud detection system, a user data and a user action data in real-time, wherein the user data and the user action data is received from a media device associated with a user, wherein the user data comprises data associated with demographic information of the user, wherein the user action data comprises data associated with actions performed by the user using the media device and interaction of the user with one or more advertisements, and wherein the user action data further comprises real-time sensor data from the media device including at least one of accelerometer data, gyroscope data, and touch sensor data;
analyzing, at the advertisement fraud detection system, the user data and the user action data in real-time, wherein the user data and the user action data is analyzed with facilitation of one or more hardware-run algorithms comprising a multi-modal machine learning model that processes the real-time sensor data to distinguish human interactions from non-human interactions;
detecting, at the advertisement fraud detection system, one or more fraudulent actions in real-time, wherein the one or more fraudulent actions are detected based on deviation in the user data and the user action data from a predefined user data and a predefined user action data respectively, and wherein the deviation is detected by mapping the user data and the user action data against a baseline human behavior profile enriched with campaign-level intelligence including at least one of time-based offers, context-based promotions, and co-branding initiatives;
identifying, at the advertisement fraud detection system, a downtime period based on historical ad performance data and statistical analysis of low human activity periods relative to high fraudulent activity;
inserting, at the advertisement fraud detection system, a set of advertisements along with the one or more advertisements in real-time during the downtime period, wherein the set of advertisements are fake advertisements inserted to attract the one or more sources performing the advertisement fraud, wherein the set of advertisements are adaptively selected based on real-time contextual data including at least one of user location, user language, and application context to create a contextual mismatch, wherein the set of advertisements are inserted in one or more formats, and wherein the set of advertisements are inserted for confirming the one or more fraudulent actions performed by the one or more sources for determining the advertisement fraud; and
sending, at the advertisement fraud detection system, one or more notifications for alerting an advertiser, wherein the one or more notifications are sent to the advertiser with facilitation of one or more mediums, wherein the one or more notifications are sent based on the one or more fraudulent actions performed using the one or more sources.

16. The computer system as recited in claim 15, wherein the user data comprising name, location, IP address, age, gender, culture, religion, marital status, nationality, education level and demographic information of the user, wherein the user action data comprising number of clicks, number of impressions, one or more transactions, one or more purchases, number of advertisements, user behavior, and the real-time sensor data including touch position, touch pressure, touch footprint, accelerometer readings, and gyroscope readings.

17. The computer system as recited in claim 15, wherein the one or more sources comprising at least one of malicious websites, an internet bot, web bot program, viruses, robots, and web crawlers.

18. The computer system as recited in claim 15, wherein the set of advertisements comprising honeypot based advertisement campaign, zero pixel advertisements, blurred advertisements, content based advertisements, and non-human clickable advertisements, and wherein the set of advertisements further comprise dynamic signatures embedded via steganographic techniques including encoding expected click coordinates and one-time tokens in pixel color values.

19. The computer system as recited in claim 15, wherein the one or more formats comprising at least one of display ads, social media ads, video ads, e-mail ads, text advertisement, audio advertisements, and graphical advertisements.

20. The computer system as recited in claim 15, wherein the one or more hardware-run algorithms comprising at least one of machine learning algorithms, artificial intelligence algorithms, neural network algorithms, and deep learning algorithms, and wherein the multi-modal machine learning model comprises a hybrid approach including an isolation forest for initial anomaly detection, a gradient boosting machine for classification, and a long short-term memory network for sequential analysis.

21. The computer system as recited in claim 15, wherein the one or more fraudulent actions comprising number of fraud clicks, fraudulent location, number of fake conversation, fraudulent behavior, fraudulent device, and fraudulent IP address, and wherein the fraudulent actions further comprise impossible travel patterns detected across sequential locations and lack of correlation with connected TV impressions in a household.

22. The computer system as recited in claim 15, wherein the one or more mediums comprising text message, email, voice notification, voice call, flash message, notification, mms and OTA messages.

23. The computer system as recited in claim 15, further comprising mapping, at the advertisement fraud detection system, the user data with the predefined user data and the user action data with the predefined user action data, wherein the mapping is performed for detecting deviation in the user data from the predefined user data and deviation in the user action data from the predefined user action data, wherein the mapping is performed for detecting the advertisement fraud performed by a fraudulent publisher, and wherein the mapping calculates a Mahalanobis distance between feature vectors and a dynamic threshold based on historical data.

24. The computer system as recited in claim 15, further comprising blocking, at the advertisement fraud detection system, the one or more fraudsters, wherein the one or more fraudsters are blocked in real time, wherein the blocking of the one or more fraudsters is performed based on the one or more fraudulent actions.

25. The computer system as recited in claim 15, further comprising performing a behavioral captcha analysis, wherein the behavioral captcha comprises analyzing interaction trajectory, micro-movement feedback from accelerometer data, and rotational feedback from gyroscope data during user interaction with an ad element to confirm human presence without explicit user challenges.

26. The computer system as recited in claim 15, further comprising applying a biometric interaction fingerprinting algorithm, the algorithm comprising:
capturing high-frequency sensor data from gyroscope and accelerometer during a touch event;
applying a Fourier transform to generate a frequency-based signature; and
classifying the signature using a neural network to distinguish human tremor patterns from flat-line bot patterns.

27. The computer system as recited in claim 15, further comprising constructing a contextual fraud graph, wherein nodes represent entities including device IDs and IP addresses, edges represent interactions, and a graph neural network detects anomalous subgraphs indicative of coordinated fraud.

28. The computer system as recited in claim 15, wherein the multi-modal machine learning model is trained using supervised learning on labeled historical datasets comprising past interactions, with periodic retraining to adapt to evolving fraud tactics, and wherein resource consumption is tiered based on user trust levels with client-side processing for initial analysis to reduce server load.

29. A non-transitory computer-readable storage medium encoding computer executable instructions that, when executed by at least one processor, performs a method for detecting advertisement fraud occurring using one or more sources in real-time, the method comprising:
receiving, at a computing device, a user data and a user action data in real-time, wherein the user data and the user action data is received from a media device associated with a user, wherein the user data comprises data associated with demographic information of the user, wherein the user action data comprises data associated with actions performed by the user using the media device and interaction of the user with one or more advertisements, and wherein the user action data further comprises real-time sensor data from the media device including at least one of accelerometer data, gyroscope data, and touch sensor data;
analyzing, at the computing device, the user data and the user action data in real-time, wherein the user data and the user action data is analyzed with facilitation of one or more hardware-run algorithms comprising a multi-modal machine learning model that processes the real-time sensor data to distinguish human interactions from non-human interactions;
detecting, at the computing device, one or more fraudulent actions in real-time, wherein the one or more fraudulent actions are detected based on deviation in the user data and the user action data from a predefined user data and a predefined user action data respectively, and wherein the deviation is detected by mapping the user data and the user action data against a baseline human behavior profile enriched with campaign-level intelligence including at least one of time-based offers, context-based promotions, and co-branding initiatives;
identifying, at the computing device, a downtime period based on historical ad performance data and statistical analysis of low human activity periods relative to high fraudulent activity;
inserting, at the computing device, a set of advertisements along with the one or more advertisements in real-time during the downtime period, wherein the set of advertisements are fake advertisements inserted to attract the one or more sources performing the advertisement fraud, wherein the set of advertisements are adaptively selected based on real-time contextual data including at least one of user location, user language, and application context to create a contextual mismatch, wherein the set of advertisements are inserted in one or more formats, and wherein the set of advertisements are inserted for confirming the one or more fraudulent actions performed by the one or more sources for determining the advertisement fraud; and
sending, at the computing device, one or more notifications for alerting an advertiser, wherein the one or more notifications are sent to the advertiser with facilitation of one or more mediums, wherein the one or more notifications are sent based on the one or more fraudulent actions performed using the one or more sources.
